(19) United States
(12) Patent Application Publication
(10) Pub. No.: US 2026/0016615 A1
(43) Pub. Date: Jan. 15, 2026

(54) OPTICAL FILM, OPTICALLY ANISOTROPIC FILM, LAMINATE, AND DISPLAY DEVICE

(71) Applicant: FUJIFILM Corporation, Tokyo (JP)

(72) Inventors: Mayumi NOJIRI, Kanagawa (JP); Naoyoshi YAMADA, Kanagawa (JP); Ayako MURAMATSU, Kanagawa (JP)

(73) Assignee: FUJIFILM Corporation, Tokyo (JP)

(21) Appl. No.: 19/331,607

(22) Filed: Sep. 17, 2025

Related U.S. Application Data
(63) Continuation of application No. PCT/JP2024/013180, filed on Mar. 29, 2024.

(30) Foreign Application Priority Data
Mar. 31, 2023 (JP) 2023-058192

(51) Int. Cl. G02B 1/11; G02B 3/00; G02B 27/01

(52) U.S. Cl. CPC G02B 1/11; G02B 3/00; G02B 27/0172; G02B 2003/0093

(57) ABSTRACT

An optical film used for manufacturing an optically anisotropic film in which occurrence of light leakage is suppressed in a case of being applied to a pancake lens-type virtual reality display device; an optically anisotropic film; a laminate; and a display device. The optical film has a change region where at least one of an in-plane retardation or an in-plane slow axis direction is changed, in which, in a case where the in-plane retardation is changed in the change region, the in-plane retardation gradually changes from a center of the change region toward an outer direction, and in a case where the in-plane slow axis direction is changed in the change region, the in-plane slow axis satisfies a predetermined requirement in the change region.

### CROSS-REFERENCE TO RELATED APPLICATIONS

This application is a Continuation of PCT International Application No. PCT/JP2024/013180 filed on Mar. 29, 2024, which was published under PCT Article 21(2) in Japanese, and which claims priority under 35 U.S.C. § 119(a) to Japanese Patent Application No. 2023-058192 filed on Mar. 31, 2023. The above applications are hereby expressly incorporated by reference, in their entirety, into the present application.

### BACKGROUND OF THE INVENTION

### 1. Field of the Invention

The present invention relates to an optical film, an optically anisotropic film, a laminate, and a display device.

### 2. Description of the Related Art

A virtual reality display device is a display device which can obtain a realistic effect as if entering a virtual world by wearing a dedicated headset on a head and visually recognizing a video displayed through a lens.

For example, in the virtual reality display device, a configuration called a pancake lens has been proposed, the lens configuration including an image display device, a reflective polarizer, a half mirror, a retardation layer, and the like, in which the entire thickness of a headset is reduced by reciprocating rays emitted from the image display device between the reflective polarizer and the half mirror.

WO2022/075475A discloses a laminated optical film including a retardation layer which converts circularly polarized light into linearly polarized light, and discloses that this laminated optical film can be applied to the virtual reality display device.

### SUMMARY OF THE INVENTION

As disclosed in WO2022/075475A, in a case where the laminated optical film is applied to the virtual reality display device, the laminated optical film may be molded into a non-planar shape such as a curved surface shape, according to the shape of the lens or the like.

The present inventors have found that, in a case where the laminated optical film including a retardation layer, as disclosed in WO2022/075475A, is formed in a curved surface shape and applied to the pancake lens-type virtual reality display device, occurrence of light leakage is observed, and it is necessary to suppress the occurrence of light leakage.

In view of the above-described circumstances, an object of the present invention is to provide an optical film used for manufacturing an optically anisotropic film in which occurrence of light leakage is suppressed in a case of being applied to a pancake lens-type virtual reality display device.

Another object of the present invention is to provide an optically anisotropic film in which occurrence of light leakage is suppressed in a case of being applied to a pancake lens-type virtual reality display device.

Another object of the present invention is to provide a laminate and a display device.

As a result of intensive studies repeatedly conducted by the present inventors on the above-described object, it has been found that the above-described object can be achieved by the following configurations.
(1) An optical film having a change region where at least one of an in-plane retardation or an in-plane slow axis direction is changed,
   in which, in a case where the in-plane retardation is changed in the change region, the in-plane retardation gradually changes from a center of the change region toward an outer direction, and
   in a case where the in-plane slow axis direction is changed in the change region, a line which passes through the center of the change region and is parallel to an average direction of in-plane slow axes of the change region is defined as a first reference line, a line which passes through the center of the change region and is orthogonal to the first reference line is defined as a second reference line, and two lines which pass through the center of the change region and form an angle of 45° with the first reference line and the second reference line are defined as third reference lines, the in-plane slow axis direction at the center is parallel to the average direction of the in-plane slow axes, and the in-plane slow axis direction on the third reference lines gradually changes from the center of the change region toward the outer direction.
(2) The optical film according to (1),
   in which, in the change region, an average value of the in-plane retardation at a
wavelength of 550 nm is 100 to 300 nm.
(3) The optical film according to (1) or (2),
   in which, in a case where the in-plane retardation is changed in the change region, the in-plane retardation gradually decreases from the center of the change region toward the outer direction.
(4) The optical film according to any one of (1) to (3),
   in which, in the change region, a point P1 and a point P2 satisfying a relationship of a requirement 1 described later are provided in two adjacent divided regions surrounded by the first reference line and the third reference lines, and
   in the change region, a point P3 and a point P4 satisfying a relationship of a requirement 2 described later are provided in two adjacent divided regions surrounded by the second reference line and the third reference lines.
(5) A laminate comprising:
   the optical film according to any one of (1) to (4); and
   an absorptive polarizer,
   in which an angle between the average direction of the in-plane slow axes of the change region in the optical film and an absorption axis of the absorptive polarizer is in a range of 40° to 50°.
(6) An optically anisotropic film having a convex curved surface portion,
   in which relationships of an expression (1) described later and an expression (2) described later are satisfied.
(7) A display device comprising:
   the optically anisotropic film according to (6).
(8) The display device according to (7),
   in which the display device is a virtual reality display device.

According to the present invention, it is possible to provide an optical film used for manufacturing an optically anisotropic film in which occurrence of light leakage is suppressed in a case of being applied to a pancake lens-type virtual reality display device.

According to the present invention, it is possible to provide an optically anisotropic film in which occurrence of light leakage is suppressed in a case of being applied to a pancake lens-type virtual reality display device.

According to the present invention, it is possible to provide a laminate and a display device.

### BRIEF DESCRIPTION OF THE DRAWINGS

FIG. 1 is a top view of an example of a first embodiment of an optical film according to the embodiment of the present invention.

FIG. 2 is a view for describing a procedure for forming a film using a forming die having a concave forming surface.

FIG. 3 is a view for describing a procedure for forming a film using a forming die having a concave forming surface.

FIG. 4 is a top view of the film used for the forming.

FIG. 5 is a view for describing a procedure for forming a film using a forming die having a convex forming surface.

FIG. 6 is a view for describing a procedure for forming a film using a forming die having a convex forming surface.

FIG. 7 is a top view of another example of the first embodiment of the optical film according to the embodiment of the present invention.

FIG. 8 is a top view of an example of a second embodiment of the optical film according to the embodiment of the present invention.

FIG. 9 is a top view of the film used for the forming.

FIG. 10 is a schematic view showing an example of a procedure for manufacturing the optical film according to the embodiment of the present invention.

FIG. 11 is a schematic view showing an example of a method for manufacturing an alignment film used in the manufacturing of the optical film according to the embodiment of the present invention.

FIG. 12 is a partially enlarged schematic view of FIG. 11.

FIG. 13 is a top view showing an example of an optically anisotropic film.

FIG. 14 is a cross-sectional view taken along a line A-A in FIG. 13.

FIG. 15 is a top view showing another example of the optically anisotropic film.

FIG. 16 is a cross-sectional view showing an example of a laminate according to the embodiment of the present invention.

FIG. 17 is a cross-sectional view showing another example of the laminate according to the embodiment of the present invention.

FIG. 18 is a cross-sectional view showing an example of a composite lens according to the embodiment of the present invention.

FIG. 19 is a view showing an example of a virtual reality display device according to the embodiment of the present invention, and shows an example of a ray of a main image.

FIG. 20 is a diagram in which results of Examples and Comparative Examples are plotted.

### DESCRIPTION OF THE PREFERRED EMBODIMENTS

Hereinafter, the present invention will be described in detail.

The description of the configuration requirements described below may be made based on representative embodiments and specific examples, but the present invention is not limited to such embodiments.

Any numerical range expressed using “to” in the present specification refers to a range including the numerical values before and after the “to” as a lower limit value and an upper limit value, respectively.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “in-plane slow axis” denotes a direction in which refractive index is maximized in a plane.

In addition, in the present specification, Re(λ) and Rth(λ) respectively represent an in-plane direction retardation at a wavelength λ and a thickness-direction retardation at a wavelength λ. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d) in AxoScan, an in-plane slow axis direction) (°), Re(λ)=R0(λ), and Rth(λ)=((nx+ny)/2−nz)×d are calculated.

Although R0(λ) is described as a numerical value calculated by AxoScan, it means Re(λ).

In addition, in the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$nx > ny \approx nz \qquad Expression ( A1 )$$

$$ny < nx \approx nz \qquad Expression ( A2 )$$

The symbol “≈” encompasses not only a case where both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of Expression (C1) and the negative C-plate satisfies a relationship of Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where the both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

A feature point of the optical film according to the embodiment of the present invention is that the optical film has a change region in which at least one of an in-plane retardation or an in-plane slow axis direction is changed.

The present inventors have studied the cause of the occurrence of the light leakage in a case where the laminated optical film including a retardation layer, disclosed in WO2022/075475A, is formed in a curved shape and applied to a pancake lens-type virtual reality display device, and have found that the light leakage occurs due to occurrence of variation in the in-plane retardation and/or variation in the in-plane slow axis direction in a plane of the retardation layer formed in a curved shape. More specifically, it is found that, in a case where the retardation layer is formed in a curved shape, there is a portion where the magnitude of the in-plane retardation and/or the orientation of the in-plane slow axis are likely to be shifted before forming and after forming, and therefore, the variation in the in-plane retardation and/or the variation in the in-plane slow axis direction occur in the formed article, and thus the light leakage is generated due to these variations. Based on the above findings, the present inventors have found that, by providing a change region in which at least one of the in-plane retardation or the in-plane slow axis direction is changed in an optical film itself used for forming, the occurrence of the variation in the in-plane retardation and/or the variation in the in-plane slow axis direction is suppressed in an optically anisotropic film (formed body) obtained by forming.

In addition, the present invention has found that the occurrence of the light leakage is suppressed by applying the optically anisotropic film having a convex curved surface portion, which satisfies predetermined requirements (relationships of expressions (1) and (2) described later), to the virtual reality display device.

In the following, first, the optical film will be described in detail, and then the optically anisotropic film will be described in detail.

### First Embodiment of Optical Film

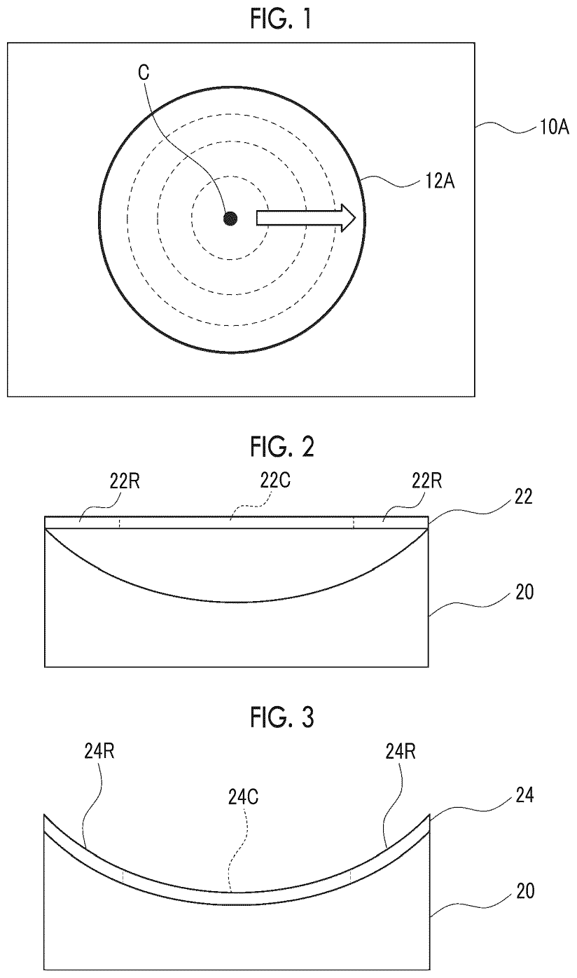

FIG. 1 is a top view of an example of a first embodiment of the optical film according to the embodiment of the present invention.

An optical film 10A has a change region 12A in which an in-plane retardation changes. The change region 12A is a region which spreads in an in-plane direction of the optical film 10A, and is a true circular shape in FIG. 1. As will be described later, the change region 12A is a region which is formed into a convex curved surface portion by forming.

In the change region 12A, as indicated by a white arrow, the in-plane retardation gradually decreases from a center C of the change region 12A toward an outer direction. More specifically, in the change region 12A, the in-plane retardation gradually decreases in a direction from the center C toward the peripheral edge of the change region 12A. That is, as indicated by a broken line in FIG. 1, the in-plane retardation continuously decreases in a concentric circular shape.

The center of the change region 12A corresponds to a centroid of the change region 12A. That is, the center of the change region in the present specification means the centroid of the change region.

In FIG. 1, the in-plane retardation continuously changes from the center C of the change region 12A toward the outer direction; but the present invention is not limited to this aspect, and the in-plane retardation may decrease stepwise.

In FIG. 1, a region other than the change region 12A in the optical film 10A may be optically anisotropic or may be isotropic.

A decrease width of the in-plane retardation from the center C of the change region 12A to the peripheral edge of the change region 12A is not particularly limited, and an optimum value is appropriately selected depending on forming conditions and the like.

Among these, in a case where the in-plane retardation gradually decreases from the center C toward the outer direction as described above, an absolute value of a difference (hereinafter, also simply referred to as “specific difference 1”) between the in-plane retardation at the center C of the change region 12A at a wavelength of 550 nm and the in-plane retardation at a position on the peripheral edge of the change region 12A at a wavelength of 550 nm is preferably 5 to 100 nm and more preferably 10 to 50 nm.

In addition, a reduction rate of the in-plane retardation from the center C of the change region 12A to the peripheral edge of the change region 12A is not particularly limited, and an optimum value is appropriately selected depending on forming conditions and the like.

Among the above, the ratio of the specific difference 1 to the distance (mm) from the center C of the change region 12A to the peripheral edge of the change region 12A (Specific difference 1/Distance (nm/mm)) is preferably 0.2 to 4 (nm/mm) and more preferably 0.4 to 2 (nm/mm).

The in-plane retardation at the center C of the change region 12A at a wavelength of 550 nm is not particularly limited, and an optimum value is selected depending on the purpose of use.

For example, in a case where an optically anisotropic film which functions as a λ/4 plate is manufactured using the optical film, the in-plane retardation at the center C of the change region 12A at a wavelength of 550 nm is preferably 130 to 250 nm and more preferably 140 to 200 nm.

In addition, in a case where an optically anisotropic film which functions as a λ/4 plate is manufactured using the optical film, the in-plane retardation at the position on the peripheral edge of the change region 12A at a wavelength of 550 nm is preferably 120 to 200 nm and more preferably 130 to 180 nm.

In FIG. 1, the change region 12A corresponds to a partial region in the in-plane direction of the optical film 10A; but the present invention is not limited to this aspect, and the entire region of the optical film 10A in the in-plane direction may be the change region.

Among these, an equivalent circle diameter of the change region 12A is preferably 20 to 80 mm and more preferably 30 to 70 mm.

The equivalent circle diameter is a diameter of a circle in a case where a perfect circle having the same area as the area of the change region 12A is assumed.

In FIG. 1, the shape of the change region 12A is a true circle; but the present invention is not limited to this aspect, and the shape of the change region may be an ellipse or an irregular shape.

The reason why the occurrence of the variation in the in-plane retardation is suppressed by manufacturing the optically anisotropic film having a convex curved surface portion using the optical film 10A having the change region 12A as described above will be described below.

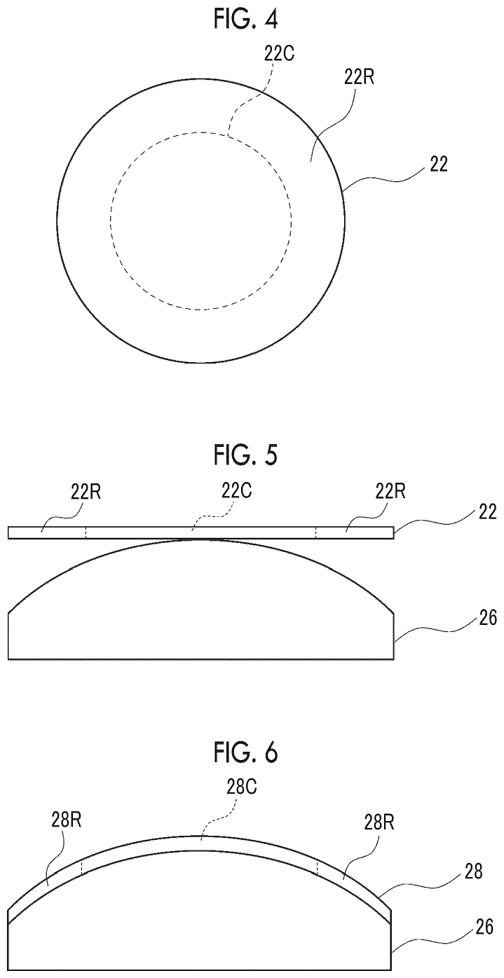

Hereinafter, first, a phenomenon occurring in a case of forming a film using a forming die having a concave forming surface will be described as an example with reference to FIGS. 2 to 4. FIGS. 2 and 3 show a procedure for forming a film using a forming die having a concave forming surface, and FIG. 4 shows the film used for the forming.

As shown in FIG. 2, a circular film 22 is placed on a forming die 20 having a concave forming surface, and as shown in FIG. 3, the film 22 is deformed along a forming surface of the forming die 20, whereby a film 24 (corresponding to a film having a convex curved surface portion) with the concave surface shape transferred is obtained.

Usually, in a case where the forming die having a concave forming surface is used, a difference in stretching ratio occurs in a center portion 22C and a periphery portion 22R surrounding the center portion 22C of the film 22, as shown in FIGS. 2 and 4. More specifically, the center portion 22C of the film 22 is more easily stretched than the periphery portion 22R of the film 22. As a result, in the film 24 on which the concave surface shape is transferred, a film thickness of a center portion 24C is smaller than a film thickness of a periphery portion 24R. As a result, the in-plane retardation at the center portion 24C is smaller than the in-plane retardation at the periphery portion 24R after the forming.

On the other hand, in a case where the concave surface shape is transferred to the change region 12A in the above-described optical film 10A in the same manner as the film 22 using a forming die having a concave forming surface, the decrease width of the in-plane retardation is large at a position close to the center C of the change region 12A before and after the forming, and the decrease width of the in-plane retardation is small at a position close to the peripheral edge of the change region 12A. As described above, in the change region 12A, originally the in-plane retardation gradually decreases from the center toward the outer direction. Therefore, the in-plane retardation after the forming in the vicinity of the center of the change region 12A and the in-plane retardation after the forming at the position in the vicinity of the peripheral edge of the change region 12A have the same magnitude. As a result, in the state after the forming of the change region 12A, the in-plane retardation is the same at any position, and the occurrence of the variation in the in-plane retardation in the in-plane direction can be suppressed.

In FIG. 1, the in-plane retardation gradually decreases from the center C of the change region 12A toward the outer direction; but, the present invention is not limited to this aspect, and the in-plane retardation may gradually increase from the center of the change region toward the outer direction.

In a case where the in-plane retardation gradually increases, the in-plane retardation may continuously increase or may increase stepwise.

In a case where the in-plane retardation gradually increases from the center of the change region toward the outer direction as described above, an increase width of the in-plane retardation from the center of the change region to the peripheral edge of the change region is not particularly limited, and an optimum value is appropriately selected depending on the forming conditions and the like.

Among these, an absolute value of a difference (hereinafter, also simply referred to as “specific difference 2”) between an in-plane retardation at the center of the change region at a wavelength of 550 nm and an in-plane retardation at a position on the periphery of the change region at a wavelength of 550 nm is preferably 5 to 100 nm and more preferably 10 to 50 nm.

In addition, an increase rate of the in-plane retardation from the center of the change region to the peripheral edge of the change region is not particularly limited, and an optimum value is appropriately selected depending on forming conditions and the like.

Among the above, the ratio of the specific difference 2 to the distance (mm) from the center of the change region to the peripheral edge of the change region (Specific difference 2/Distance (nm/mm)) is preferably 0.2 to 4 (nm/mm) and more preferably 0.4 to 2 (nm/mm).

In a case where the in-plane retardation gradually increases from the center of the change region toward the outer direction as described above, the in-plane retardation at the center of the change region at a wavelength of 550 nm is not particularly limited, and an optimum value is selected depending on the purpose of use.

For example, in a case where an optically anisotropic film which functions as a λ/4 plate is manufactured using the optical film, the in-plane retardation at the center of the change region at a wavelength of 550 nm is preferably 120 to 200 nm and more preferably 130 to 180 nm.

In addition, in a case where an optically anisotropic film which functions as a λ/4 plate is manufactured using the optical film, the in-plane retardation at the position on the peripheral edge of the change region at a wavelength of 550 nm is preferably 130 to 250 nm and more preferably 140 to 200 nm.

As described above, in a case where the in-plane retardation gradually increases from the center toward the outer direction in the change region, it is preferable to perform forming using a forming die having a convex forming surface.

Hereinafter, first, a phenomenon occurring in a case of forming a film using a typical forming die having a convex forming surface will be described with reference to FIGS. 4 to 6. FIGS. 5 and 6 show a procedure for forming a film using a forming die having a convex forming surface, and FIG. 4 shows the film used for the forming.

As shown in FIG. 5, a circular film 22 is placed on a forming die 26 having a convex forming surface, and as shown in FIG. 6, the film 22 is deformed along a forming surface of the forming die 26, whereby a film 28 with the convex surface shape transferred is obtained.

Usually, in a case where the forming die having a convex forming surface is used, a difference in stretching ratio occurs in a center portion 22C and a periphery portion 22R of the film 22, as shown in FIGS. 5 and 6. More specifically, the periphery portion 22R of the film 22 is more easily stretched than the center portion 22C of the film 22. As a result, in the film 28 on which the convex surface shape is transferred, a film thickness of a periphery portion 28R is smaller than a film thickness of a center portion 28C. As a result, the in-plane retardation at the periphery portion 28R is smaller than the in-plane retardation at the center portion 28C after the forming.

On the other hand, in a case where the convex surface shape is transferred to the change region portion where the in-plane retardation gradually increases from the center toward the outer direction using a forming die having a convex forming surface, as in the above-described film 22, the decrease width of the in-plane retardation is small at a position close to the center of the change region, and the decrease width of the in-plane retardation is large at a position close to the peripheral edge of the change region. Therefore, the in-plane retardation after the forming in the vicinity of the center of the change region and the in-plane retardation after the forming at the position in the vicinity of the peripheral edge of the change region have the same magnitude. That is, in the state after the forming of the change region where the in-plane retardation gradually increases from the center toward the outer direction, the in-plane retardation is the same at any position, and the occurrence of the variation in the in-plane retardation in the in-plane direction can be suppressed.

In FIG. 1, the aspect in which the in-plane retardation changes in a concentric circular shape in the change region 12A has been described; but the present invention is not limited to this aspect as long as the in-plane retardation gradually changes from the center toward the outer direction.

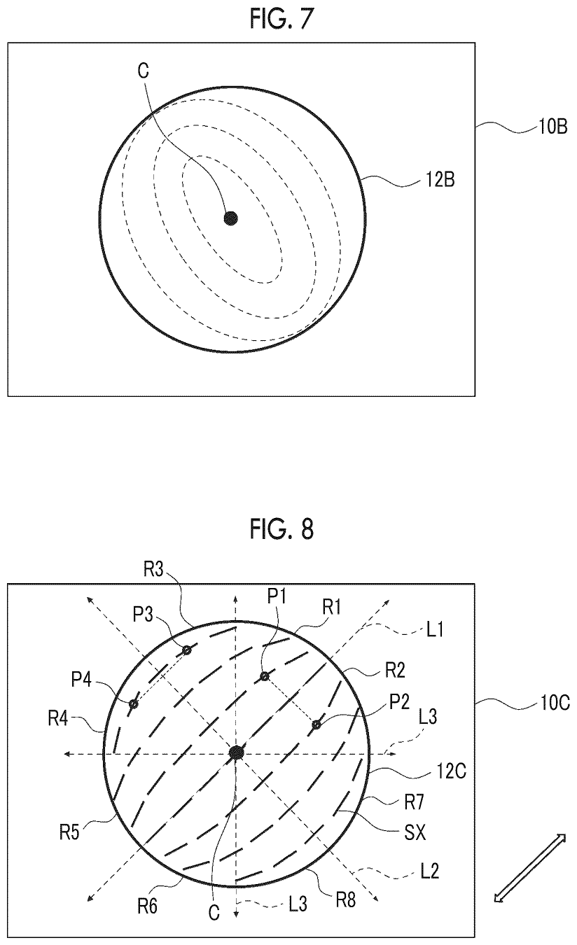

For example, as shown in FIG. 7, an optical film 10B has a change region 12B, and as indicated by a broken line, the in-plane retardation may gradually change in a concentric elliptical shape from a center C of the change region 12B toward an outer direction. In the aspect in which the in-plane retardation gradually changes in a concentric elliptical shape, the in-plane retardation may gradually decrease or may gradually increase.

In a case where the in-plane retardation gradually changes in a concentric elliptical shape, an angle formed between a major axis of the ellipse and an average direction of in-plane slow axes in the change region is preferably in a range of 70° to 110° and more preferably in a range of 80° to 100°.

In a case where the center of the change region is further extended to a greater extent during the forming of the change region, the aspect in which the in-plane retardation gradually changes in a concentric circular shape is preferable. In addition, in a case where the periphery of the change region is extended to a greater extent during the forming of the change region, the aspect in which the in-plane retardation gradually changes in a concentric elliptical shape is preferable.

The average direction of in-plane slow axes of the change region can be measured by a method described later.

### Second Embodiment of Optical Film

FIG. 8 is a top view of an example of a second embodiment of the optical film according to the embodiment of the present invention.

An optical film 10C has a change region 12C in which an in-plane slow axis direction is changed. The change region 12C is a region which spreads in an in-plane direction of the optical film 10C, and is a true circular shape in FIG. 8. As will be described later, the change region 12C is a region which is formed into a convex curved surface portion by forming. In FIG. 8, a region other than the change region 12C in the optical film 10C may be optically anisotropic or may be isotropic.

In FIG. 8, a solid line SX in the change region 12C represents the in-plane slow axis direction at each position. As shown in FIG. 8, in the change region 12C, the in-plane slow axis direction is changed.

In FIG. 8, a direction indicated by a white arrow is an average direction of in-plane slow axes of the change region 12C. The average direction is a direction in which directions of 1,000 or more in-plane slow axes of the change region 12C are averaged.

The above-described average direction of in-plane slow axes can be obtained using a known device, and can be measured using, for example, a polarization camera. The polarization camera is a camera which can acquire polarization information of a subject. The type of the polarization camera is not particularly limited, and examples thereof include a device in which a polarization filter including a plurality of polarizers is mounted on a sensor array (imaging element).

In addition, the above-described measurement can also be performed using a two-dimensional birefringence evaluation system.

Examples of the two-dimensional birefringence evaluation system used in the present invention include a two-dimensional birefringence evaluation system (WPA-200) manufactured by Photonic Lattice, Inc. For example, in the above-described two-dimensional birefringence evaluation system, the direction of the absorption axis at 10,000 to 200,000 positions can be obtained.

In a case where the in-plane slow axis direction at each position in the change region is measured using a device such as a polarization camera and a two-dimensional birefringence evaluation system, the measurement is performed by disposing the device in a direction corresponding to the normal direction of the optical film.

In FIG. 8, a line which passes through the center C of the change region 12C and is parallel to the average direction (the direction of the white arrow in FIG. 8) of in-plane slow axes of the change region 12C is defined as a first reference line L1, a line which passes through the center C of the change region 12C and is orthogonal to the first reference line is defined as a second reference line L2, and two lines which pass through the center C of the change region 12C and form an angle of 45° with the first reference line L1 and the second reference line L2 are defined as third reference lines L3.

The center of the change region 12C corresponds to a centroid of the change region 12C.

In the change region 12C, the in-plane slow axis direction at the center C is parallel to the average direction of in-plane slow axes of the change region 12C. In addition, the term “parallel” includes a range of errors allowed in the technical field to which the present invention belongs; and in the present invention, an angle formed by the in-plane slow axis at the center C and the average direction of in-plane slow axes of the change region 12C may be in a range of 0° to 5°. Among these, the above-described angle is preferably in a range of 0° to 3°.

In addition, in the change region 12C, the in-plane slow axis direction on the third reference lines L3 gradually changes from the center C of the change region 12C toward the outer direction.

More specifically, in a direction from the center C of the change region 12C to the paper plane upward in FIG. 8, the third reference lines L3 and the in-plane slow axis, represented by three solid lines shown in the drawing, intersect with each other, and an angle (acute angle) formed by the in-plane slow axis and the third reference lines L3 gradually increases from the center C to the outer direction. That is, an angle (acute angle) formed by the in-plane slow axis at each position on the third reference lines L3 and the third reference lines gradually increases from the center C toward the outer direction.

In addition, even in a direction from the center C of the change region 12C to the paper plane downward in FIG. 8, an angle (acute angle) between the in-plane slow axis at each position on the third reference lines L3 and the third reference lines gradually increases from the center C toward the outer direction.

In addition, in a direction from the center C of the change region 12C to the right direction of the paper plane in FIG. 8, an angle (acute angle) between the in-plane slow axis at each position on the third reference lines L3 and the third reference lines gradually increases from the center C toward the outer direction.

Furthermore, in a direction from the center C of the change region 12C to the left direction of the paper plane in FIG. 8, an angle (acute angle) between the in-plane slow axis at each position on the third reference lines L3 and the third reference lines gradually increases from the center C toward the outer direction.

In FIG. 8, the angle between the in-plane slow axis direction at each position and the third reference lines continuously changes from the center C of the change region 12C on the third reference lines toward the outer direction; but the present invention is not limited to this aspect, and the angle may decrease stepwise.

The magnitude of the angle formed by the in-plane slow axis at the center C of the change region 12C and the in-plane slow axis at the position on the third reference lines and at the peripheral edge of the change region is not particularly limited, but is often 0.4° to 5° and more often 0.4° to 3°.

The reason why the occurrence of the variation in the in-plane slow axis direction is suppressed by manufacturing the optically anisotropic film having a convex curved surface portion using the optical film 10C having the change region 12C as described above will be described below.

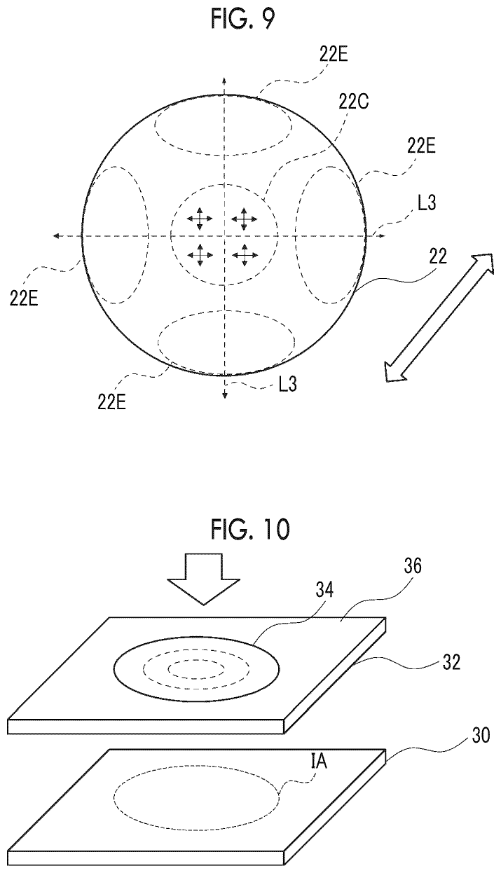

Hereinafter, first, a phenomenon occurring in a case of forming a film using a forming die having a concave forming surface will be described as an example with reference to FIGS. 2, 3, and 9. FIGS. 2 and 3 show a procedure for forming a film using a forming die having a concave forming surface, and FIG. 9 shows the film used for the forming. In FIG. 9, a direction of a white arrow represents the average direction of in-plane slow axes, and two third reference lines L3 drawn by the above-described procedure are shown.

As shown in FIG. 2, a circular film 22 is placed on a forming die 20 having a concave forming surface, and as shown in FIG. 3, the film 22 is deformed along a forming surface of the forming die 20, whereby a film 24 with the concave surface shape transferred is obtained.

In a case where the film is formed using the forming die having a concave forming surface shown in FIGS. 2 and 3, there is a difference in the direction in which the film 22 is stretched at the position of the film. More specifically, as shown in FIG. 9, since the center portion 22C of the film 22 is stretched during forming in various directions as indicated by arrows, the deviation in the in-plane slow axis direction is less likely to occur before and after the forming. On the other hand, in four end part regions 22E near the peripheral edge of the film and near the two third reference lines L3, the in-plane slow axis direction is likely to be shifted before and after the forming because the film is likely to be stretched only in a specific direction. That is, during the forming, the case of occurrence of the deviation in the in-plane slow axis direction varies depending on the position on the film to be formed.

On the other hand, in a case where the concave surface shape is transferred to the change region 12C in the above-described optical film 10C in the same manner as in the film 22 using a forming die having a concave forming surface, as the in-plane slow axis direction at a position corresponding to the vicinity of the end portion region 22E described in FIG. 9 is originally a direction deviated from the in-plane slow axis direction at the center, the in-plane slow axis directions at any position after the forming are the same direction, and thus the deviation in the in-plane slow axis direction is less likely to occur.

As shown in FIG. 8, in the change region 12C, it is preferable that the in-plane slow axis directions at each position on the first reference line and the second reference line are parallel to the in-plane slow axis direction at the center C of the change region 12C.

The term “parallel” includes a range of errors allowed in the technical field to which the present invention belongs; and in the present invention, an angle formed by the in-plane slow axes at each position on the first reference line and the second reference line and the in-plane slow axis at the center C of the change region 12C may be in a range of 0° to 5°. Among these, the above-described angle is preferably in a range of 0° to 3°.

In addition, in the change region of the optical film according to the embodiment of the present invention, it is preferable that, in a case where two lines forming an angle of 22.5° with the first reference line and the third reference line are defined as a fourth reference line, the in-plane slow axis direction on the fourth reference line gradually changes from the center of the change region toward the outer direction. For example, in the change region 12C shown in FIG. 8, it is preferable that an angle (acute angle) formed by the in-plane slow axis at each position on the fourth reference line (not shown) and the fourth reference line gradually increases from the center C toward the outer direction.

In a case where the above-described angle gradually increases, the angle may increase continuously or may increase stepwise.

Furthermore, in the change region of the optical film according to the embodiment of the present invention, it is preferable that, in a case where two lines forming an angle of 22.5° with the second reference line L2 and the third reference line L3 are defined as a fifth reference line, the in-plane slow axis direction on the fifth reference line gradually changes from the center of the change region toward the outer direction. For example, in the change region 12C shown in FIG. 8, it is preferable that an angle (acute angle) formed by the in-plane slow axis at each position on the fifth reference line (not shown) and the fifth reference line gradually increases from the center C toward the outer direction.

In a case where the above-described angle gradually increases, the angle may increase continuously or may increase stepwise.

In the change region 12C, a point P1 and a point P2 satisfying a relationship of the following requirement 1 are provided in two adjacent divided regions (a combination of a divided region R1 and a divided region R2 and a combination of a divided region R5 and a divided region R6) surrounded by the first reference line L1 and the third reference lines L3.

Requirement 1: an orientation of inclination of an in-plane slow axis at the point P1 with respect to the first reference line, the point P1 being provided in one region of the two adjacent divided regions surrounded by the first reference line and the third reference lines, is opposite to an orientation of inclination of an in-plane slow axis at the point P2 with respect to the first reference line, the point P2 being provided in the other region of the two divided regions, being located on a line which passes through the point P1 and is orthogonal to the first reference line, and having a distance from the first reference line on the orthogonal line, which is equal to that of the point P1.

It is preferable that the optical film according to the embodiment of the present invention satisfies the requirement 1.

In the following, as a representative example, the requirement 1 will be described in detail with the point P1 located in the divided region R1 and the point P2 located in the divided region R2, as shown in FIG. 8.

In FIG. 8, the divided region R1 surrounded by the first reference line L1 and one third reference line L3 is a fan-shaped region, and a central angle thereof is 45°. In addition, the divided region R2 surrounded by the first reference line L1 and the other third reference line L3 is also a fan-shaped region, and a central angle thereof is 45°. The divided region R1 and the divided region R2 are adjacent to each other through the first reference line L1.

In the change region 12C, the point P1 and the point P2 are provided in the divided region R1 and the divided region R2, respectively, with the relationship in which the orientation of inclination of the in-plane slow axis at the point P1 located in the divided region R1 with respect to the first reference line L1 and the orientation of inclination of the in-plane slow axis at the point P2 located in the divided region R2 and having a predetermined positional relationship with the point P1 are opposite to each other. The position of the point P2 is located on a line (broken line in FIG. 8) which passes through the point P1 and is orthogonal to the first reference line L1. Furthermore, the position of the point P2 is such that a distance from the first reference line L1 on the orthogonal line (broken line in FIG. 8) is equal to that of the point P1.

That is, in other words, a straight line (broken line in FIG. 8) connecting the point P1 and the point P2 is orthogonal to the first reference line L1, and a length of the straight line from the point P1 to the first reference line L1 is equal to a length of the straight line from the point P2 to the first reference line L1. In addition, the in-plane slow axis at the point P1 is inclined in a direction in which one end on the center C side is away from the first reference line L1, and the in-plane slow axis at the point P2 is also inclined in a direction in which one end on the center C side is away from the first reference line L1, and the directions of the inclination of both are opposite to each other. More specifically, in FIG. 8, the in-plane slow axis at the point P1 is present at a position rotated clockwise with respect to the first reference line L1, and the in-plane slow axis at the point P2 is present at a position rotated counterclockwise with respect to the first reference line L1.

The angle of the above-described inclination of the in-plane slow axis at the point P1 with respect to the first reference line L1 is the same as the angle of the above-described inclination of the in-plane slow axis at the point P2 with respect to the first reference line L1. That is, the rotation angle of the in-plane slow axis at the point P1 in the clockwise direction with respect to the first reference line L1 and the rotation angle of the in-plane slow axis at the point P1 in the counterclockwise direction with respect to the first reference line L1 are the same angle.

In FIG. 8, the combination of the divided region R5 and the divided region R6 is present as the two adjacent divided regions surrounded by the first reference line L1 and the third reference lines L3.

Although not shown in FIG. 8, in the divided region R5 and the divided region R6, the points P1 and P2 satisfying the relationship of the above-described requirement 1 are also provided.

In addition, in the change region 12C, a point P3 and a point P3 satisfying a relationship of the following requirement 2 are provided in two adjacent divided regions (a combination of a divided region R3 and a divided region R4 and a combination of a divided region R7 and a divided region R8) surrounded by the second reference line L2 and the third reference lines L3.

Requirement 2: an orientation of inclination of an in-plane slow axis at the point P3 with respect to the second reference line, the point P3 being provided in one region of the two adjacent divided regions surrounded by the second reference line and the third reference lines, is opposite to an orientation of inclination of an in-plane slow axis at the point P4 with respect to the second reference line, the point P4 being provided in the other region of the two divided regions, being located on a line which passes through the point P3 and is orthogonal to the second reference line, and having a distance from the second reference line on the orthogonal line, which is equal to that of the point P3.

It is preferable that the optical film according to the embodiment of the present invention satisfies the requirement 2.

In the following, as a representative example, the requirement 2 will be described in detail with the point P3 located in the divided region R3 and the point P4 located in the divided region R4, as shown in FIG. 8.

In FIG. 8, the divided region R3 surrounded by the second reference line L2 and one third reference line L3 is a fan-shaped region, and a central angle thereof is 45°. In addition, the divided region R4 surrounded by the second reference line L2 and the other third reference line L3 is also a fan-shaped region, and a central angle thereof is 45°. The divided region R3 and the divided region R4 are adjacent to each other through the second reference line L2.

In the change region 12C, the point P3 and the point P4 are provided in the divided region R3 and the divided region R4, respectively, with the relationship in which the orientation of inclination of the in-plane slow axis at the point P3 located in the divided region R3 with respect to the second reference line L2 and the orientation of inclination of the in-plane slow axis at the point P4 located in the divided region R4 and having a predetermined positional relationship with the point P3 are opposite to each other. The position of the point P4 is located on a line (broken line in FIG. 8) which passes through the point P3 and is orthogonal to the second reference line L2. Furthermore, the position of the point P4 is such that a distance from the second reference line L2 on the orthogonal line (broken line in FIG. 8) is equal to that of the point P3.

That is, in other words, a straight line (broken line in FIG. 8) connecting the point P3 and the point P4 is orthogonal to the second reference line L2, and a length of the straight line from the point P3 to the second reference line L2 is equal to a length of the straight line from the point P4 to the second reference line L2. In addition, the in-plane slow axis at the point P3 is inclined in a direction in which one end on the center C side is away from the second reference line L2, and the in-plane slow axis at the point P4 is also inclined in a direction in which one end on the center C side is away from the second reference line L2, and the directions of the inclination of both are opposite to each other. More specifically, in FIG. 8, the in-plane slow axis at the point P3 is present at a position rotated clockwise with respect to the second reference line L2, and the in-plane slow axis at the point P4 is present at a position rotated counterclockwise with respect to the second reference line L2.

The angle of the above-described inclination of the in-plane slow axis at the point P3 with respect to the second reference line L2 is the same as the angle of the above-described inclination of the in-plane slow axis at the point P4 with respect to the second reference line L2. That is, the rotation angle of the in-plane slow axis at the point P3 in the clockwise direction with respect to the second reference line L2 and the rotation angle of the in-plane slow axis at the point P4 in the counterclockwise direction with respect to the second reference line L2 are the same angle.

In FIG. 8, the combination of the divided region R7 and the divided region R8 is present as the two adjacent divided regions surrounded by the second reference line L2 and the third reference lines L3.

Although not shown in FIG. 8, in the divided region R7 and the divided region R8, the points P3 and P4 satisfying the relationship of the above-described requirement 2 are also provided.

As described above, in FIG. 8, an angle A1 between the in-plane slow axis at the point P1 and the first reference line L1 and an angle A2 between the in-plane slow axis at the point P2 and the first reference line L1 are the same; but the present invention is not limited to this aspect, and an absolute value of a difference between the angle A1 and the angle A2 is preferably within 5° and more preferably within 3°. The lower limit thereof is not particularly limited, and may be 0°.

In addition, as described above, in FIG. 8, an angle A3 between the in-plane slow axis at the point P3 and the second reference line L2 and an angle A4 between the in-plane slow axis at the point P4 and the second reference line L2 are the same; but the present invention is not limited to this aspect, and an absolute value of a difference between the angle A3 and the angle A4 is preferably within 5° and more preferably within 3°. The lower limit thereof is not particularly limited, and may be 0°.

In FIG. 8, only one point P1 and one point P2 satisfying the relationship of the requirement 1 are described; but the present invention is not limited to this aspect, and it is preferable that a plurality of points P1 and P2 satisfying the relationship of the requirement 1 are provided.

Among the above, it is preferable that the two positions which are located within the two adjacent divided regions surrounded by the first reference line and the third reference lines, are located on the two fourth reference lines described above, and face each other across the first reference line correspond to the points P1 and P2 satisfying the requirement 1 at any position.

In addition, in FIG. 8, only one point P3 and one point P4 satisfying the relationship of the requirement 2 are described; but the present invention is not limited to this aspect, and it is preferable that a plurality of points P3 and P4 satisfying the relationship of the requirement 2 are provided.

Among the above, it is preferable that the two positions which are located within the two adjacent divided regions surrounded by the second reference line and the third reference lines, are located on the two fifth reference lines described above, and face each other across the second reference line correspond to the points P3 and P4 satisfying the requirement 2 at any position.

It is preferable that the inclination of the in-plane slow axis, with respect to the first reference line L1, at each position in the two adjacent divided regions (the combination of the divided region R1 and the divided region R2 and the combination of the divided region R5 and the divided region R6) surrounded by the first reference line L1 and the third reference lines L3 in the change region 12C increases as the distance from the first reference line L1 increases. For example, in FIG. 8, it is preferable that the inclination of the in-plane slow axis at a position farther from the first reference line L1 than the point P1 with respect to the first reference line L1 is larger than the inclination of the in-plane slow axis at the point P1 with respect to the first reference line L1.

In addition, it is preferable that the inclination of the in-plane slow axis, with respect to the second reference line L2, at each position in the two adjacent divided regions (the combination of the divided region R3 and the divided region R4 and the combination of the divided region R7 and the divided region R8) surrounded by the second reference line L2 and the third reference lines L3 in the change region 12C increases as the distance from the second reference line L2 increases. For example, in FIG. 8, it is preferable that the inclination of the in-plane slow axis at a position farther from the second reference line L2 than the point P3 with respect to the second reference line L2 is larger than the inclination of the in-plane slow axis at the point P3 with respect to the second reference line L2.

### Third Embodiment of Optical Film

A third embodiment of the optical film is a film having both the above-described feature of the first embodiment and the above-described feature of the second embodiment.

That is, examples of the third aspect of the optical film include a film having a change region in which both the in-plane retardation and the in-plane slow axis direction are changed.

The aspect in which the in-plane retardation is changed in the change region and the aspect in which the in-plane slow axis directions is changed in the change region are as described in the first embodiment and the second embodiment, respectively, and the description thereof will be omitted here.

### <Other Characteristics of Optical Film>

A film thickness of the optical film (first to third embodiments) is not particularly limited, but from the viewpoint that the occurrence of the light leakage in the virtual reality display device is further suppressed (hereinafter, also simply referred to as “viewpoint that the effect of the present invention is more excellent”), it is preferably 0.5 to 5.0 μm and more preferably 1.0 to 3.0 μm.

The above-described film thickness is an average value obtained by measuring the film thickness of the optical film at 10 locations, and arithmetically averaging the measured values.

An average value of in-plane retardations of the change region in the optical film at a wavelength of 550 nm is not particularly limited, but from the viewpoint of the use as various retardation plates such as a λ/4 plate, it is preferably 120 to 200 nm and more preferably 130 to 170 nm.

The average value of in-plane retardations is an average value obtained by measuring the in-plane retardation at a wavelength of 550 nm at 50 or more positions in the change region of the optical film, and arithmetically averaging the measured values.

It is preferable that a relationship of an expression (X) is satisfied at any position of the change region of the optical film.

$$Re ( 450 ) \leq Re ( 550 ) \leq Re ( 650 ) \qquad Expression ( Y )$$

In addition, it is preferable that a relationship of an expression (Y) is satisfied at any position of the change region of the optical film.

$$0.72 \leq Re ( 450 ) / Re ( 550 ) \leq 0.92 \qquad Expression ( Y )$$

### <Material Contained in Optical Film>

Materials contained in the above-described optical film (first to third embodiments) are not particularly limited, and examples thereof include a liquid crystal compound. As will be described later, it is preferable that the optical film is formed of a composition containing a liquid crystal compound having a polymerizable group.

As the liquid crystal compound, both a high-molecular-weight liquid crystal compound and a low-molecular-weight liquid crystal compound can be used, and from the viewpoint of increasing the alignment degree, a high-molecular-weight liquid crystal compound is preferable. In addition, the high-molecular-weight liquid crystal compound and the low-molecular-weight liquid crystal compound may be used in combination as the liquid crystal compound. The liquid crystal compound may be immobilized in the optically anisotropic film.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

The low-molecular-weight liquid crystal compound is not particularly limited, and examples thereof include a rod-like liquid crystal compound and a disk-like liquid crystal compound. In addition, a liquid crystal compound having reverse wavelength dispersibility may be used as the low-molecular-weight liquid crystal compound.

The low-molecular-weight liquid crystal compound preferably has a polymerizable group. As the polymerizable group, a polymerizable group which is radically polymerizable or cationically polymerizable is preferable. Specific examples of the polymerizable group include an acryloyloxy group, a methacryloyloxy group, an alicyclic ether group, a cyclic acetal group, a cyclic lactone group, a cyclic thioether group, a spiroorthoester group, and a vinyloxy group.

Examples of the high-molecular-weight liquid crystal compound include thermotropic liquid crystalline polymers described in JP2011-237513A.

In a case where the optically anisotropic film contains the high-molecular-weight liquid crystal compound, it is preferable that the high-molecular-weight liquid crystal compound forms a nematic liquid crystal phase. A temperature range at which the nematic liquid crystal phase is exhibited is preferably room temperature (23° C.) to 450° C., and more preferably 50° C. to 400° C. from the viewpoint of handleability and manufacturing suitability.

As will be described later, the optical film is preferably formed of a liquid crystal compound having a polymerizable group.

The optical film may contain an adhesion improver, a plasticizer, a polymer, and the like, in addition to the above-described components.

Here, examples of the adhesion improver include reactive additives described in paragraphs [0123] to [0129] of JP2019-91088A and boronic acid monomers described in paragraphs [0015] to [0028] of WO2015/053359A.

### <Method for Manufacturing Optical Film>

A method for manufacturing the optical film is not particularly limited, and examples thereof include known methods.

Examples of the method for manufacturing the optical film according to the first embodiment include a method (method 1) of forming a coating film using a composition containing a liquid crystal compound having a polymerizable group, aligning the liquid crystal compound in the coating film, and irradiating the coating film with light such that the coating film has a distribution of irradiation amounts in an in-plane direction of the coating film to manufacture an optical film.

Hereinafter, the above-described method 1 will be described in detail.

In the method 1, first, a coating film is formed of a composition containing a liquid crystal compound having a polymerizable group.

The composition used in the method 1 contains a liquid crystal compound having a polymerizable group. The liquid crystal compound having a polymerizable group is as described above.

The composition may contain a component other than the liquid crystal compound (for example, a solvent and a polymerization initiator) as necessary.

Examples of the method of forming a coating film include a method of applying the composition onto a substrate.

The substrate to be used is not particularly limited, and a known planar substrate can be used.

In addition, an alignment film may be provided on the substrate as necessary. By providing the alignment film, the liquid crystal compound can be aligned. Examples of the alignment film include a photo-alignment film.

Examples of the method of applying the composition include known methods such as a roll coating method, a gravure printing method, a spin coating method, a wire bar coating method, an extrusion coating method, a direct gravure coating method, a reverse gravure coating method, a die-coating method, a spraying method, and an ink jet method.

Next, a treatment of aligning the liquid crystal compound in the coating film is performed.

The alignment treatment may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystal compound contained in the composition may be aligned by the above-described coating treatment or drying treatment.

In a case where the drying treatment is performed at a temperature equal to or higher than a transition temperature of the liquid crystal compound contained in the coating film from a liquid crystal phase to an isotropic phase, a heat treatment described below may not be performed.

It is preferable that the alignment treatment includes a heat treatment. As a result, the liquid crystal compound contained in the coating film can be aligned.

From the viewpoint of manufacturing suitability, the heat temperature is preferably 10° C. to 250° C. and more preferably 25° C. to 190° C. In addition, the heating time is preferably 1 to 300 seconds and more preferably 1 to 60 seconds.

The alignment treatment may include a cooling treatment performed after the heat treatment. The cooling treatment is a treatment of cooling the coating film after the heating. In this manner, the alignment of the liquid crystal compound contained in the coating film can be fixed. A cooling unit is not particularly limited, and the cooling treatment can be performed according to a known method. As the cooling temperature, the optimum temperature is selected depending on the liquid crystal compound used.

Next, the coating film is irradiated with light such that the coating film has a distribution of irradiation amounts in an in-plane direction of the coating film.

Examples of a more specific method include a method in which, in a case of producing an optical film having a change region where the in-plane retardation gradually decreases from the center toward the outer direction, the coating film is irradiated with light such that the irradiation amount gradually decreases from the center toward the outer direction in a predetermined range while maintaining the temperature during the cooling treatment performed in the alignment treatment, and then a heat treatment is performed.

In the above-described procedure, the degree of polymerization of the liquid crystal compound is adjusted by changing the irradiation amount during the light irradiation. The degree of polymerization of the liquid crystal compound is high in the center where the irradiation amount is large, and the degree of polymerization of the liquid crystal compound is low in the peripheral edge where the irradiation amount is small. In a case where the coating film subjected to the light irradiation as described above is subjected to a heat treatment, the alignment of the liquid crystal compound hardly changes in the vicinity of the center where the degree of polymerization is high; but the alignment of the liquid crystal compound is disturbed in the vicinity of the peripheral edge where the degree of polymerization is low, and as a result, the in-plane retardation decreases.

Examples of the method of irradiating the coating film with light such that the coating film has a distribution of irradiation amounts in the in-plane direction of the coating film as described above include a method of using a filter in which a transmittance changes from the center toward the outer direction. For example, a method of exposing a coating film 30 through a filter 32 having a transmissive region 34 through which light is transmitted and a light shielding region 36 is shown in FIG. 10. In the transmissive region 34, the transmittance gradually decreases in a concentric circular shape from the center toward the outer direction. In a case where the exposure is performed from the direction of the white arrow in FIG. 10, a distribution of the transmitted amounts is generated by the transmissive region 34, and as a result, a distribution of the exposure amounts is generated from the center toward the outer direction in an irradiation region IA of the coating film 30.

In addition, during the above-described heat treatment, light irradiation may be further performed. In a case of the light irradiation during the heat treatment, the light irradiation may be performed such that the distribution of the irradiation amounts is generated, or the light irradiation may be performed such that the irradiation amount is the same over the entire surface. In a case where the light irradiation is performed such that the irradiation amount is distributed together with the heat treatment, it is preferable that the light irradiation is performed such that the irradiation amount gradually increases from the center toward the outer direction. In a case where such a distribution of the irradiation amounts is provided during the heat treatment, the disorder of the alignment of the liquid crystal compound is likely to occur at a position where the irradiation amount is high. That is, a difference in the in-plane retardation can be provided between the vicinity of the center of the irradiation region and the vicinity of the peripheral edge of the irradiation region.

The type of light used in the above-described light irradiation is not particularly limited, and various types of light such as infrared rays, visible light, and ultraviolet rays can be used, but ultraviolet rays are preferable.

A temperature of the heat treatment performed together with the light irradiation is not particularly limited, but is preferably 10° C. to 250° C. and more preferably 25° C. to 190° C.

In addition to the above-described method 1, for example, a temperature distribution can be provided during light irradiation to generate a distribution of in-plane retardations. More specifically, in a case where a heat treatment is performed such that the heating temperature gradually increases from the center toward the outer direction in the region where the light irradiation is performed, the polymerization of the liquid crystal compound proceeds while the alignment of the liquid crystal compound is maintained in a region having a low heating temperature. However, the polymerization of the liquid crystal compound proceeds while the alignment of the liquid crystal compound is disturbed in a region having a high heating temperature. Therefore, it is possible to form the change region where the in-plane retardation is high in the vicinity of the center and the in-plane retardation gradually decreases toward the outside.

In the above description, the method for manufacturing the optical film according to the first embodiment has been described in detail, but the optical film according to the second embodiment can also be manufactured by a known method.

Examples thereof include a method of forming an alignment film in which a liquid crystal compound can be aligned in a predetermined direction, and aligning the liquid crystal compound on the alignment film to manufacture an optical film. Examples of the above-described alignment film include a photo-alignment film which has been subjected to a predetermined photo-alignment treatment.

Examples of a method of preparing the photo-alignment film as described above include a method of using a wire grid and a mask having a predetermined opening portion. Hereinafter, the method will be described in detail.

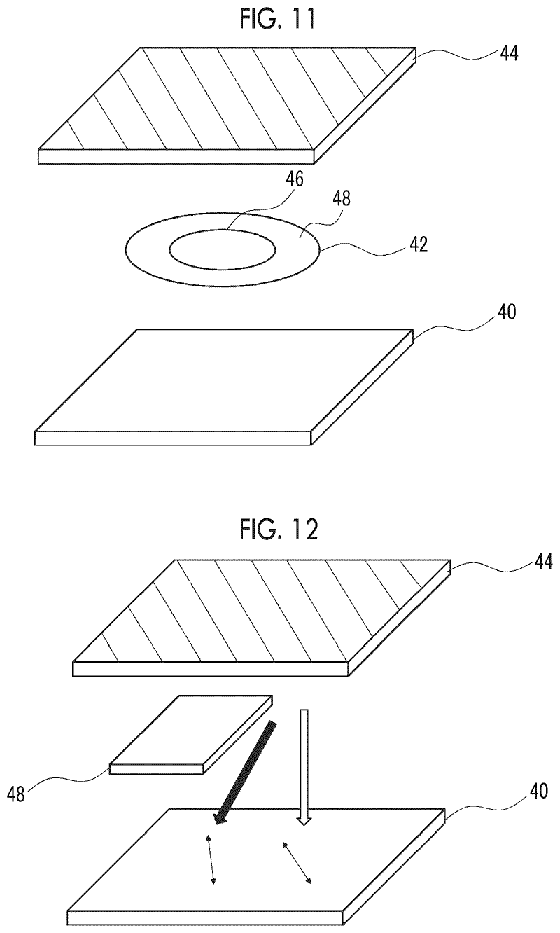

As shown in FIG. 11, a mask 42 and a wire grid 44 are disposed on an alignment film 40 including a photo-aligned group. The mask 42 is an annular mask having an opening portion 46 and a light shielding portion 48. The wire grid 44 has a function of transmitting light parallel to a direction indicated by a diagonal line shown in FIG. 11. The mask 42 and the wire grid 44 are disposed on the alignment film 40, and exposure is performed from the wire grid 44 side.

FIG. 12 is a partially enlarged view of the optical system in a case where the exposure is performed in the optical system shown in FIG. 11. Among the polarized light components transmitted through the wire grid 44, as indicated by a white arrow, the polarized light components traveling in a normal direction of the wire grid 44 are irradiated to the alignment film 40 as they are, and the alignment film 40 is imparted with an alignment restriction force capable of aligning the liquid crystal compound in a specific direction indicated by a black arrow.

On the other hand, among the polarized light components transmitted through the wire grid 44, as indicated by the black arrow, polarized light which is emitted in an oblique direction with respect to the wire grid 44 and goes under the light shielding portion 48 of the mask 42 is present. The polarization direction of such polarized light is shifted from the polarization direction of the polarized light emitted in the direction indicated by the white arrow described above by a predetermined angle. Therefore, due to the influence of the polarized light which goes under the light shielding portion 48, the direction of the alignment restriction force, which is indicated by the black arrow, at the position where the polarized light is irradiated is different from the direction of the alignment restriction force at the position where the polarized light is irradiated, which is indicated by the white arrow. In particular, as shown in FIGS. 11 and 12, since the mask 42 has an annular shape, the deviation of the direction of the alignment restriction force increases from the center toward the outer direction, and an alignment film capable of forming the change region of the optical film according to the second embodiment described above can be obtained.

In the above description, the aspect in which a predetermined mask is used has been described, but a photo-alignment film having an alignment restriction force in a specific direction at each position can also be manufactured by irradiating an alignment film including a photo-aligned group with light by direct drawing.

The above-described optical film according to the second embodiment can be manufactured by applying a composition containing a liquid crystal compound having a polymerizable group onto the photo-alignment film obtained by the above-described method to align the liquid crystal compound in the coating film, and further subjecting the coating film to a light irradiation treatment.

As the method of aligning the liquid crystal compound and the method of the light irradiation treatment, the method and the conditions described in the above-described method 1 are appropriately selected.

### <Laminate>

The above-described optical film may be laminated as another member.

For example, a laminate including an optical film and an absorptive polarizer may be used.

In the above-described laminate, an angle formed between an average direction of in-plane slow axes of the change region in the optical film and an absorption axis of the absorptive polarizer is preferably in a range of 40° to 50°.

The average direction of in-plane slow axes of the change region is as described above.

Examples of the absorptive polarizer include an iodine-based polarizer, a dye-based polarizer using a dichroic dye, and a polyene-based polarizer. Examples of the iodine-based polarizer and the dye-based polarizer include a coating type polarizer and a stretching type polarizer, and both polarizers can be applied. As the coating type polarizer, a polarizer in which a dichroic organic coloring agent is aligned by using alignment of the liquid crystal compound is preferable, and as the stretching type polarizer, a polarizer produced by adsorbing iodine or a dichroic dye on polyvinyl alcohol and stretching the polyvinyl alcohol is preferable.

A thickness of the absorptive polarizer is not particularly limited, but is preferably 3 to 60 μm and more preferably 5 to 20 μm.

### <Method of Forming Optical Film>

An optically anisotropic film having a convex curved surface portion can be manufactured using the optical film having the change region described above. A method of forming the optical film is not particularly limited, and a known method is adopted.

For example, the change region may be formed into a convex curved surface portion using the forming die having a concave forming surface as shown in FIGS. 2 and 3, or the change region may be formed into a convex curved surface portion using the forming die having a convex forming surface as shown in FIGS. 6 and 7.

In a case of forming the optical film according to the first embodiment described above, a method of adjusting heating conditions of the optical film during the forming is exemplified.

For example, in a case where the film is formed using the forming die having a concave forming surface as shown in FIGS. 2 and 3, there is a difference in the direction in which the film is stretched at the position of the film as described above. In particular, as described above, as shown in FIG. 9, since the center portion 22C of the film 22 is stretched during forming in various directions as indicated by arrows, the deviation in the in-plane slow axis direction is less likely to occur before and after the forming. On the other hand, since the end part region 22 is stretched only in a specific direction, the in-plane slow axis direction is likely to be shifted before and after the forming depending on the position. That is, during the forming, the case of occurrence of the deviation in the in-plane slow axis direction varies depending on the position on the film to be formed.

The method of adjusting the heating conditions of the film to be formed is exemplified as a solution to the above-described problem.

Specifically, the method is a method of heating the optical film in an in-plane direction such that a temperature distribution is provided, thereby forming the film. More specifically, examples thereof include, in a case of concave surface forming, a method of heating the change region in the optical film such that a heating temperature of a periphery portion surrounding a center portion of the change region in the optical film is lower than a heating temperature of the center portion, and deforming the heated change region in the optical film along a forming surface of a forming die having a concave forming surface.

In the above-described procedure, a heating temperature of the periphery portion is set to be lower than a heating temperature of the center portion of the change region in the optical film disposed on the forming die having a concave forming surface, thereby making the center portion easily stretched and making the periphery portion difficult to be stretched in a case where the change region in the optical film is deformed along the forming surface. That is, as described above, in general, in the forming using the forming die having a concave forming surface, the deviation in the in-plane slow axis direction occurs at the periphery portion rather than the center portion. However, by changing the heating conditions for the center portion and the periphery portion, the center portion which is less likely to be extended due to the stretching is more likely to be extended, and the periphery portion which is likely to be extended due to the stretching is less likely to be extended. As a result, the deviation in the in-plane slow axis direction is suppressed in the change region of the deformed optical film.

As described above, by adopting a predetermined method in a case of forming the optical film according to the first embodiment, it is possible to suppress both the occurrence of the variation in the in-plane retardation and the occurrence of the variation in the in-plane slow axis direction.

Heating conditions of the optical film are appropriately selected depending on the type of the material of the optical film to be used, the shape of the convex curved surface portion, and the forming method.

Among these, the heating temperature is preferably equal to or higher than a glass transition temperature of the optical film. The upper limit of the heating temperature is not particularly limited, but is preferably a temperature within (Glass transition temperature of optical film+100° C.).

The heating method is not particularly limited, and examples thereof include heating by bringing the light absorption anisotropic film into contact with a heated solid, heating by bringing the light absorption anisotropic film into contact with a heated liquid, heating by bringing the light absorption anisotropic film into contact with a heated gas, heating by irradiation with infrared rays, and heating by irradiation with microwaves. Among these, heating by irradiation with infrared rays is preferable.

A wavelength of the infrared rays used for the heating is preferably 1.0 to 30.0 μm and more preferably 1.5 to 5 μm.

Examples of the infrared ray (IR) light source include a near-infrared lamp heater in which a tungsten filament is enclosed into a quartz tube, and a wavelength control heater in which a mechanism for cooling a part between quartz tubes with air is provided by multiplexing the quartz tubes. As a method of providing intensity distribution of the infrared irradiation, a method of varying the density of the arrangement of the IR light sources, or a method of placing a filter with a patterned transmittance to infrared light between the IR light sources and the planar optical film can be used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, or the like is used. A temperature of the optical film is controlled by the intensity of the infrared irradiation, and by the infrared irradiation time or the illuminance of the infrared irradiation. The temperature of the planar optical film can be monitored using a non-contact radiation thermometer, a thermocouple, or the like, and the forming can be performed at a target temperature.

In the above description, the method of heating the optical film such that the distribution of the heating temperature is provided in the in-plane direction has been described above, but the present invention is not limited to the above-described method as long as the temperature distribution occurs in the in-plane direction of the optical film during the forming. For example, a method of uniformly heating the optical film in the in-plane direction, performing a cooling treatment such that the temperature of the periphery portion is lower than the temperature of the center portion before forming, and then performing forming to generate the temperature distribution of the optical film in the in-plane direction may be used. The cooling treatment is not particularly limited, and examples thereof include a method of adjusting a pressurization speed in a case of pressing the film against the forming die to lower the temperature of the periphery portion, and a method of bringing only the periphery portion into contact with a refrigerant.

In a case of forming the optical film according to the first embodiment described above, by increasing the curvature radius, the occurrence of the deviation in the in-plane slow axis direction in the obtained formed body can be suppressed.

The method of forming the optical film has been described above, but the above-described laminate may be formed by the same procedure to form the optically anisotropic film having a convex curved surface portion.

### <Optically Anisotropic Film>

The optically anisotropic film according to the embodiment of the present invention is an optically anisotropic film having a convex curved surface portion, in which relationships of an expression (1) and an expression (2) are satisfied.

$${( Δ Re )}^{1 / 2} + {( Δ axis )}^{1 / 2} \leq 10 \times ( L / R - 0.1 ) \qquad Expression ( 1 )$$

$$L / R \geq 0.3 \qquad Expression ( 2 )$$

R represents a numerical value R in a case where a minimum curvature radius of the convex curved surface portion is denoted by R (mm).

L represents a numerical value L in a case where a half value of an equivalent circle diameter of the convex curved surface portion as observed from a normal direction of a tangent plane at an apex of the convex curved surface portion is denoted by L (mm).

ΔRe represents a numerical value ΔRe in a case where a the largest difference in in-plane retardation among differences of in-plane retardation at two positions on the convex curved surface portion at a wavelength of 550 nm is denoted by ΔRe (nm).

Δaxis represents a numerical value Δaxis in a case where the largest angle among angles between in-plane slow axes at the two positions on the convex curved surface portion as observed from the normal direction of the tangent plane at the apex of the convex curved surface portion is denoted by Δaxis (°).

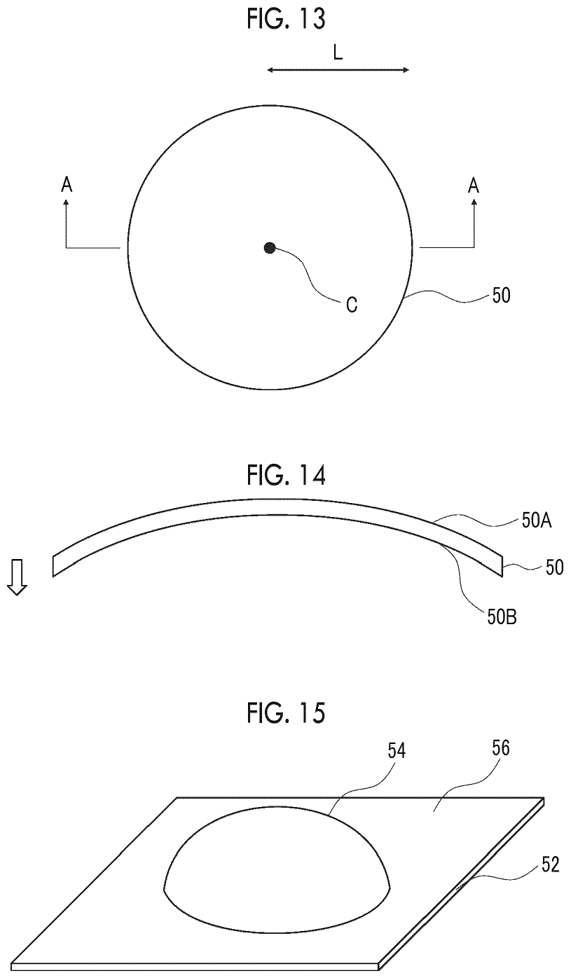

Hereinafter, the expression (1) and the expression (2) will be described with reference to FIGS. 13 and 14, showing an example of the optically anisotropic film.

FIG. 13 shows an example of the optically anisotropic film according to the embodiment of the present invention.

FIG. 13 is a top view of the optically anisotropic film, and FIG. 14 is a cross-sectional view taken along a line A-A of FIG. 13. The line A-A is a line passing through a center C of an optically anisotropic film 50 which is circular in a plan view.

As shown in FIGS. 13 and 14, the optically anisotropic film 50 has a convex curved surface shape. More specifically, as shown in FIG. 14, the optically anisotropic film 50 has a shape (convex shape) which is convexly curved toward the upper side of the paper plane. That is, the optically anisotropic film 50 has a convex shape protruding to one surface side. It can be said that the optically anisotropic film 50 has a concave shape in which the other surface side is concave.

In the optically anisotropic film 50 shown in FIGS. 13 and 14, the entire film corresponds to the convex curved surface portion.

As shown in FIG. 14, the optically anisotropic film 50 has a first surface 50A and a second surface 50B facing each other, in which the first surface 50A is a convex curved surface toward the upper side of the paper plane, and the second surface 50B is a convex curved surface toward the upper side of the paper plane.

The curved surface shape of the optically anisotropic film 50 shown in FIGS. 13 and 14 is a rotational parabolic surface shape, but may be a spherical shape or a rotational ellipsoid shape.

As shown in FIG. 14, in a case where the optically anisotropic film 50 is observed from a normal direction of a tangent plane of the center C (corresponding to an apex of a convex portion) of the optically anisotropic film 50 (in a case where the optically anisotropic film 50 is viewed in a plan view), the shape of the optically anisotropic film 50 is a true circular shape.

The center C of the optically anisotropic film 50 is an intersection between an axis of a rotational parabolic surface shape and the optically anisotropic film 50, and corresponds to a position where the axis of the rotational parabolic surface shape intersects with a normal line of an emission surface of n image display panel in a case where the optically anisotropic film 50 is incorporated into a virtual reality display device described later.

In addition, in a case where the optically anisotropic film 50 is incorporated into a virtual reality display device described later, the optically anisotropic film 50 is disposed to be convex toward the image display panel side.

In the expression (1), R represents a numerical value R in a case where the minimum curvature radius of the convex curved surface portion is denoted by R (mm). For example, in a case where R (mm) is 40 mm, R is 40.

The minimum curvature radius (R (mm)) of the convex curved surface portion is not particularly limited, and an optimum value is appropriately selected depending on the use application of the optically anisotropic film; but it is 25 to 200 mm in many cases and 35 to 100 mm in more cases.

The curvature radius of the convex curved surface portion of the optically anisotropic film may be constant or may vary at any position of the convex curved surface portion. In a case where the curvature radius varies depending on the position of the convex curved surface portion, the minimum value thereof is selected and used as the above-described minimum curvature radius.

A method of measuring the above-described curvature radius is not particularly limited, and examples thereof include a method using a device such as a spherical meter and a laser interferometer.

In the expression (1), L represents a numerical value L in a case where a half value of an equivalent circle diameter of the convex curved surface portion as observed from a normal direction of a tangent plane at an apex of the convex curved surface portion is denoted by L (mm). For example, in a case where L (mm) is 25 mm, L is 25.

The half value (L (mm)) of the equivalent circle diameter of the convex curved surface portion is not particularly limited, and an optimum value is appropriately selected depending on the use application of the optically anisotropic film; but it is 5 to 50 mm in many cases and 15 to 35 mm in more cases.

FIG. 13 corresponds to a view observed from the normal direction of the tangent plane at the apex of the convex curved surface portion of the optically anisotropic film 50; and as described above, since the optically anisotropic film 50 itself is a true circle, in the aspect shown in FIG. 13, the distance from the center C to the outer edge corresponds to the L.

In the expression (1), ΔRe represents a numerical value ΔRe in a case where a the largest difference in in-plane retardation among differences of in-plane retardation at two positions on the convex curved surface portion at a wavelength of 550 nm is denoted by ΔRe (nm). For example, in a case where ΔRe (nm) is 1.0 nm, ΔRe is 1.0.

The difference (ΔRe (nm)) in the largest in-plane retardation is not particularly limited, and an optimum value is appropriately selected depending on the use application of the optically anisotropic film; but it is 0 to 12 nm in many cases and preferably 0 to 5 nm from the viewpoint that the effect of the present invention is more excellent.

The measurement of the in-plane retardation at each position of the convex curved surface portion at a wavelength of 550 nm can be performed using a known device, and examples thereof include a two-dimensional birefringence evaluation system (WPA-200) manufactured by Photonic Lattice, Inc. In a case where the above-described measurement is performed, the above-described measurement is performed from the normal direction of the tangent plane at the apex of the convex curved surface portion.

Since the measurement error is large in a range of 2.5 cm from the peripheral edge in the projection diagram of the convex curved surface portion in a case of being observed from the normal direction of the tangent plane at the apex of the convex curved surface portion, the range is excluded from the measurement range of ΔRe.

In the expression (1), Δaxis represents a numerical value Δaxis in a case where the largest angle among angles between in-plane slow axes at the two positions on the convex curved surface portion as observed from the normal direction of the tangent plane at the apex of the convex curved surface portion is denoted by Δaxis (°). For example, in a case where Δaxis (°) is 0.1°, Δaxis is 0.1.

The largest angle (Δaxis (°)) is not particularly limited, and an optimum value is appropriately selected depending on the use application of the optically anisotropic film; but it is 0° to 3.0° in many cases and 0° to 2.0° in more cases. Among these, 0° to 1.5° is preferable from the viewpoint that the effect of the present invention is more excellent.

The measurement of the in-plane slow axis at each position of the convex curved surface portion can be performed using a known device, and examples thereof include a two-dimensional birefringence evaluation system (WPA-200) manufactured by Photonic Lattice, Inc. In a case where the above-described measurement is performed, the above-described measurement is performed from the normal direction of the tangent plane at the apex of the convex curved surface portion.

Since the measurement error is large in a range of 2.5 cm from the peripheral edge in the projection diagram of the convex curved surface portion in a case of being observed from the normal direction of the tangent plane at the apex of the convex curved surface portion, the range is excluded from the measurement range of Δaxis.

The following expression (1) is an expression including the variables ΔRe, Δaxis, L, and R described above, and the expression (2) is an expression including the variables L and R described above.

The present inventors have found that, in a case where the relationship of the expression (1) and the relationship of the expression (2) are satisfied, the occurrence of the light leakage, which is the object of the present invention, can be suppressed.

$${( Δ Re )}^{1 / 2} + {( Δ axis )}^{1 / 2} \leq 10 \times ( L / R - 0.1 ) \qquad Expression ( 1 )$$

$$L / R \geq 0.3 \qquad Expression ( 2 )$$

The difference between (ΔRe)^{1/2}+ (Δaxis)^{1/2} and 10×(L/R−0.1) is not particularly limited, but is preferably 0 to 9 and more preferably 4 to 9.

The upper limit of L/R is not particularly limited, but is 0.80 or less in many cases and 0.70 or less in more cases.

In a cross section of the optically anisotropic film 50 on a plane including a normal line of a tangent plane of the center C of the optically anisotropic film 50, an outer contour line of the optically anisotropic film 50 (contour line corresponding to the first surface 50A of the optically anisotropic film 50) is a parabola.

In addition, even in a case where the optically anisotropic film 50 is cut on any plane parallel to the tangent plane of the center C of the optically anisotropic film 50, an outer contour line of the optically anisotropic film 50 (contour line corresponding to the first surface 50A of the optically anisotropic film 50) is circular.

In addition, in a direction (direction of a white arrow in FIG. 14) in which the normal line of the tangent plane of the center C of the optically anisotropic film 50 extends from the first surface 50A toward the second surface 50B, a diameter of a circle formed by the outer contour line of the optically anisotropic film 50 in a case where the optically anisotropic film 50 is cut along a plane parallel to the tangent plane of the center C of the optically anisotropic film 50 gradually increases.

In the optically anisotropic film 50 shown in FIGS. 13 and 14, the entire optically anisotropic film 50 corresponds to the convex curved surface portion; but the present invention is not limited to this aspect, and a part of the region of the optically anisotropic film may be the convex curved surface portion.

For example, in an optically anisotropic film 52 shown in FIG. 15, a convex curved surface portion 54 and a plane portion 56 are provided, and the convex curved surface portion satisfies the above-described requirements 1 and 2.

A shape of the convex curved surface portion of the optically anisotropic film is preferably a spherical shape, a rotational ellipsoid shape, or a rotational parabolic surface shape. That is, it is preferable that the convex curved surface portion is a spherical shape portion, a rotational ellipsoid shape portion, or a rotational parabolic surface shape portion.

As described above, the shape of the convex curved surface portion of the optically anisotropic film is preferably a revolution body shape.

In FIGS. 13 and 14, an aspect in which the shape of the convex curved surface portion of the optically anisotropic film is a true circular shape in a plan view has been described; but the present invention is not limited to this aspect, and the shape of the convex curved surface portion of the optically anisotropic film in a plan view may be an elliptical shape or another shape.

A film thickness of the optically anisotropic film is not particularly limited, but from the viewpoint that the effect of the present invention is more excellent, it is preferably 0.5 to 50 μm and more preferably 1 to 10 μm.

The film thickness of the optically anisotropic layer is an average value, and is obtained by measuring film thicknesses of 10 or more positions of the optically anisotropic film, and calculating an arithmetic mean thereof.

Examples of materials contained in the optically anisotropic film include the above-described liquid crystal compound. The liquid crystal compound may be immobilized in the optically anisotropic film. Among these, the optically anisotropic film is preferably a film formed of a composition containing a liquid crystal compound, and more preferably a film formed of a composition containing a liquid crystal compound having a polymerizable group.

A method for manufacturing the optically anisotropic film is not particularly limited, and a known method is adopted.

For example, as described above, a method of forming the change region of the optical film having the change region by the above-described predetermined method can be mentioned. In a case where only the change region of the optical film is formed, the other non-formed portion may be cut and removed as necessary. More specifically, for example, the optically anisotropic film 50 as shown in FIG. 13 may be manufactured by forming only the change region of the optical film having the change region to manufacture the optically anisotropic film 52 as shown in FIG. 15, and then removing the plane portion 56.

### <Laminate>

The optically anisotropic film according to the embodiment of the present invention may be combined with other members to form a laminate.

The other members are not particularly limited, and examples thereof include a linear polarizer, a cholesteric liquid crystal layer, a linear polarization-type reflective polarizer, a surface antireflection layer, a pressure-sensitive adhesive layer, a support, and an alignment film.

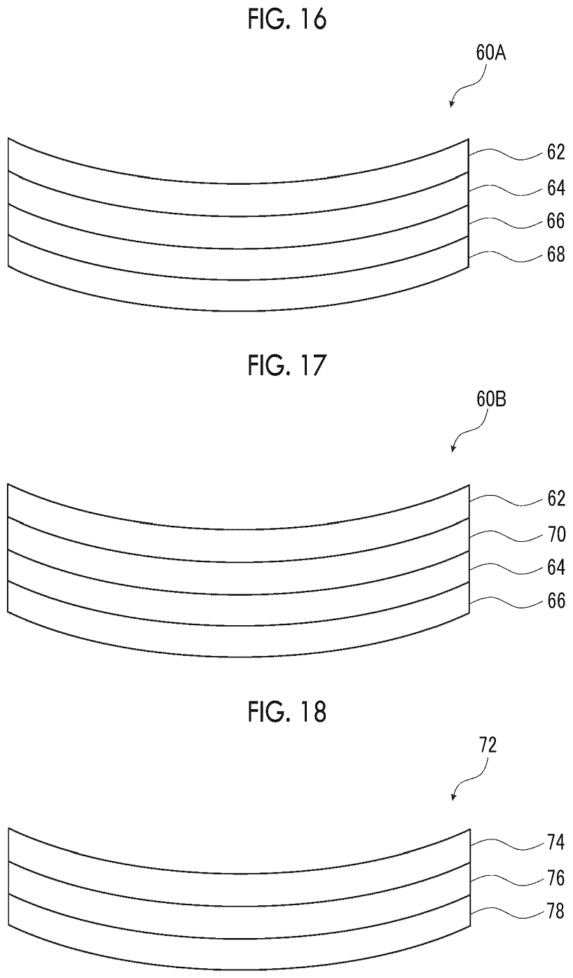

FIG. 16 shows an example of the laminate.

A laminate 60A shown in FIG. 16 includes an absorptive polarizer 62, an optically anisotropic film 64, a positive C-plate 66, and a cholesteric liquid crystal layer 68 in this order.

FIG. 17 shows another example of the laminate according to the embodiment of the present invention.

A laminate 60B shown in FIG. 17 includes an absorptive polarizer 62, a linear polarization-type reflective polarizer 70, an optically anisotropic film 64, and a positive C-plate 66 in this order.

The optically anisotropic film 64 is the above-described optically anisotropic film according to the embodiment of the present invention, having a convex curved surface portion.

As shown in FIGS. 16 and 17, any member included in the laminate 60A and the laminate 60B has the same curved surface shape as the optically anisotropic film 64 according to the embodiment of the present invention.

The laminate 60A and the laminate 60B include two retardation layers of the optically anisotropic film 64 and the positive C-plate 66.

A retardation layer having a function of converting linearly polarized light into circularly polarized light may be further disposed on a side of the absorptive polarizer 62 of the laminate 60A, opposite to the optically anisotropic film 64 side. In addition, a retardation layer having a function of converting linearly polarized light into circularly polarized light may be further disposed on a side of the absorptive polarizer 62 of the laminate 60B, opposite to the linear polarization-type reflective polarizer 70 side.

The laminates 60A and 60B are suitably applied to a virtual reality display device described later.

The optically anisotropic film 64 is the above-described optically anisotropic film according to the embodiment of the present invention. The optically anisotropic film 64 functions as a λ/4 plate.

The λ/4 plate is a plate having a λ/4 function, specifically, a plate having a function of converting linearly polarized light having a specific wavelength (preferably, visible light) into circularly polarized light (or converting circularly polarized light into linearly polarized light).

It is preferable that an angle between an average direction of in-plane slow axes of the optically anisotropic film 64 and a transmission axis of the absorptive polarizer 62 is within a range of 45°±10°.

The average direction of in-plane slow axes of the optically anisotropic film 64 is a direction in which directions of 1,000 or more in-plane slow axes of the optically anisotropic film 64 are averaged.

Hereinafter, other members other than the optically anisotropic film, included in the laminate, will be described in detail.

### (Absorptive Polarizer)

Examples of a configuration of the absorptive polarizer include the configuration described in the absorptive polarizer which can be laminated with the above-described optical film.

(Retardation Layer Having Function of Converting Linearly Polarized Light into Circularly Polarized Light)

The retardation layer having a function of converting linearly polarized light into circularly polarized light (hereinafter, also simply referred to as “specific retardation layer”) is one kind of retardation layer.

The specific retardation layer is not particularly limited as long as it has a function of converting linearly polarized light into circularly polarized light, and examples thereof include a λ/4 plate.

The λ/4 plate is as described above.

The specific retardation layer may have reverse wavelength dispersibility. The expression “having reverse wavelength dispersibility” denotes that as the wavelength increases, the value of the phase difference at the wavelength increases.

In addition, the specific retardation layer may have a multilayer structure, and specific examples thereof include a broadband λ/4 plate obtained by laminating a λ/4 plate and a λ/2 plate.

An angle formed by an in-plane slow axis of the specific retardation layer and an absorption axis of the absorptive polarizer is not particularly limited, but is preferably within a range of 45°±10°.

The specific retardation layer may be a layer formed by immobilizing a liquid crystal compound twist-aligned with a thickness direction as a helical axis. For example, a retardation layer having a layer formed by immobilizing a rod-like liquid crystal compound or a disk-like liquid crystal compound twist-aligned with a thickness direction as a helical axis, as described in JP05753922B and JP05960743B, can be used.

A thickness of the specific retardation layer is not particularly limited, but is preferably 0.1 to 8 μm and more preferably 0.3 to 5 μm.

### (Positive C-Plate)

The positive C-plate functions as an optical compensation layer for increasing the degree of polarization of the transmitted light with respect to light incident obliquely.

The in-plane retardation of the positive C-plate at a wavelength of 550 nm is preferably 10 nm or less.

The thickness-direction retardation of the positive C-plate at a wavelength of 550 nm is preferably −600 to −40 nm.

A material constituting the positive C-plate is not particularly limited, but it is preferable that the positive C-plate is formed of a composition containing a liquid crystal compound. Such a positive C-plate can be typically obtained by vertically aligning a rod-like polymerizable liquid crystal compound contained in the polymerizable liquid crystal composition and fixing the alignment state by polymerization. In addition, the positive C-plate can also be formed of a composition containing a side chain-type polymer liquid crystal compound as the liquid crystal compound.

A thickness of the positive C-plate is not particularly limited, but from the viewpoint of thinning, it is preferably 0.5 to 10 μm and more preferably 0.5 to 5 μm.

### (Cholesteric Liquid Crystal Layer)

The cholesteric liquid crystal layer is an optical member which separates incidence ray into right-circularly polarized light and left-circularly polarized light, and specularly reflects one circularly polarized light and transmits the other circularly polarized light.

Examples of the cholesteric liquid crystal layer include a cholesteric liquid crystal layer obtained by fixing a cholesteric liquid crystalline phase. From the viewpoint that a decrease in degree of polarization and a distortion of a polarization axis are suppressed in a case of being stretched or formed into a three-dimensional shape, the cholesteric liquid crystal layer is preferably used as an optical film for curved surface forming. In addition, a decrease in degree of polarization due to the distortion of the polarization axis is unlikely to occur.

It is preferable that the cholesteric liquid crystal layer includes a blue light reflecting layer in which at least reflectivity at a wavelength of 460 nm is 40% or more, a green light reflecting layer in which a reflectivity at a wavelength of 550 nm is 40% or more, a yellow light reflecting layer in which a reflectivity at a wavelength of 600 nm is 40% or more, and a red light reflecting layer in which a reflectivity at a wavelength of 650 nm is 40% or more. With such a configuration, high reflection characteristics can be exhibited over a wide wavelength range in the visible region, which is preferable. The above-described reflectivity is a reflectivity in a case where non-polarized light is incident on the cholesteric liquid crystal layer at each wavelength.

In addition, the cholesteric liquid crystal layer may have a pitch gradient structure in which a helical pitch of the cholesteric liquid crystalline phase continuously changes in the thickness direction.

In addition, it is also preferable that a cholesteric liquid crystal layer obtained by fixing a cholesteric liquid crystalline phase containing a rod-like liquid crystal compound and a cholesteric liquid crystal layer obtained by fixing a cholesteric liquid crystalline phase containing a disk-like liquid crystal compound are used in combination as the cholesteric liquid crystal layer. In such a configuration, since the cholesteric liquid crystalline phase containing a rod-like liquid crystal compound has a positive Rth and the cholesteric liquid crystalline phase containing a disk-like liquid crystal compound has a negative Rth, the Rth of each other is offset, and thus the occurrence of the tint unevenness can be suppressed even for the light incident from the oblique direction, which is preferable.

A thickness of the cholesteric liquid crystal layer is not particularly limited, but from the viewpoint of thinning, it is preferably 30 μm or less and more preferably 15 μm or less. The lower limit thereof is not particularly limited, but is 1 μm or more in many cases.

### (Linear Polarization-Type Reflective Polarizer)

The linear polarization-type reflective polarizer is a polarizer having a function of reflecting one linearly polarized light of linearly polarized light components orthogonal to each other, and allowing transmission of the other linearly polarized light components.

Examples of the linear polarization-type reflective polarizer include a film obtained by stretching a dielectric multi-layer film and a wire grid polarizer. Examples of a commercially available product include a reflective type polarizer (trade name: APF) manufactured by 3M and a wire grid polarizer (trade name: WGF) manufactured by Asahi Kasei Corporation.

An angle formed by a transmission axis of the linear polarization-type reflective polarizer and a transmission axis of the absorptive polarizer is preferably within a range of 0° to 10°.

### (Surface Antireflection Layer)

The laminate according to the embodiment of the present invention may include a surface antireflection layer.

In the laminate according to the embodiment of the present invention, the surface antireflection layer is preferably disposed on the outermost surface side. The surface antireflection layer may be disposed only on one surface side of the laminate, or may be disposed on both surface sides of the laminate.

The type of the surface antireflection layer is not particularly limited, but from the viewpoint of further decreasing the reflectivity, a moth-eye film or an anti reflection (AR) film is preferable. In addition, since the antireflection property can be maintained even in a case where the film thickness fluctuates due to stretching and forming, a moth-eye film is preferable.

### (Pressure-Sensitive Adhesive Layer)

The laminate according to the embodiment of the present invention may or may not include a pressure-sensitive adhesive layer. In a case where the laminate includes a pressure-sensitive adhesive layer, the number of pressure-sensitive adhesive layers is preferably one or two.

Examples of a pressure-sensitive adhesive constituting the pressure-sensitive adhesive layer include a pressure sensitive adhesive and an adhesive.

Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive; and among these, an acrylic pressure sensitive adhesive (pressure-sensitive adhesive) is preferable.

Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet curable adhesive, and a visible light-curable adhesive; and among these, an ultraviolet curable adhesive is preferable.

A thickness of the pressure-sensitive adhesive layer is not particularly limited, but from the viewpoint of thinning, it is preferably 25 μm or less, more preferably 15 μm or less, and still more preferably 5 μm or less. The lower limit thereof is not particularly limited, but is 0.1 μm or more in many cases.

### (Support)

The laminate according to the embodiment of the present invention may include a support.

The support can be provided at any position, and for example, in a case where the cholesteric liquid crystal layer and the retardation layer are a film used by being transferred from the temporary support, the support can be used as a transfer destination thereof.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, as the support, a cellulose acylate film, a cyclic polyolefin film, polyacrylate, a polyacrylate film, or a polymethacrylate film is preferable. In addition, commercially available cellulose acetate films (for example, “TD80U” or “Z-TAC” manufactured by FUJIFILM Corporation) can also be used.

In addition, it is preferable that the support has a small phase difference. Specifically, an in-plane retardation at a wavelength of 550 nm is preferably 10 nm or less, and an absolute value of the thickness-direction retardation at a wavelength of 550 nm is preferably 50 nm or less.

A thickness of the support is not particularly limited, and is preferably 5 to 300 μm, more preferably 5 to 100 μm, and still more preferably 5 to 30 μm.

### (Method for Manufacturing Laminate)

A method for manufacturing the laminate according to the embodiment of the present invention is not particularly limited, and examples thereof include known methods.

For example, the laminate may be manufactured by bonding other members to the surface of the optically anisotropic film having a convex curved surface portion, through the pressure-sensitive adhesive layer; or a laminate for forming may be manufactured by bonding other members to the surface of the above-described optical film through the pressure-sensitive adhesive layer, and then performing the forming method of the optical film using the laminate for molding to form the laminate for forming into a predetermined shape, thereby manufacturing the laminate including the optically anisotropic film having a convex curved surface portion.

### <Composite Lens>

The composite lens according to the embodiment of the present invention includes the above-described laminate, a lens, and a half mirror in this order.

FIG. 18 shows an example of the composite lens according to the embodiment of the present invention.

A composite lens 72 includes a laminate 74, a lens 76, and a half mirror 78 in this order.

As shown in FIG. 18, any member included in the composite lens 72 has a curved surface shape similar to that of the optically anisotropic film.

A configuration of the laminate 74 is as described above, and includes the optically anisotropic film having a convex curved surface portion.

Hereinafter, members other than the laminate, included in the composite lens, will be described in detail.

### (Lens)

The composite lens includes a lens.

Examples of the lens include a convex lens and a concave lens.

Examples of the convex lens include a biconvex lens, a plano-convex lens, and a convex meniscus lens. Examples of the concave lens include a biconcave lens, a plano-concave lens, and a concave meniscus lens.

As the lens used in the virtual reality display device, a convex meniscus lens or a concave meniscus lens is preferable from the viewpoint of enlarging the angle of view, and a concave meniscus lens is more preferable from the viewpoint that chromatic aberration can be further suppressed.

As a material of the lens, a material transparent to visible light, such as glass, crystal, and plastic, can be used. Since the birefringence of the lens causes rainbow-like unevenness or light leakage, it is preferable that the birefringence is small, and a material having zero birefringence is more preferable.

### (Half Mirror)

The composite lens according to the embodiment of the present invention includes a half mirror. The half mirror is a known half mirror in the related art, which allows transmission of about half of incident light and reflects the remaining half of the incident light.

A transmittance of the half mirror is preferably 50±30% and more preferably 50±10%.

The type of the half mirror is not particularly limited, and examples thereof include a reflective layer containing a metal. Examples of the metal include silver and aluminum.

A thickness of the reflective layer is preferably 1 to 20 nm, more preferably 2 to 10 nm, and still more preferably 3 to 6 nm.

### <Virtual Reality Display Device>

The virtual reality display device according to the embodiment of the present invention includes the above-described optically anisotropic film, the above-described laminate, or the above-described composite lens.

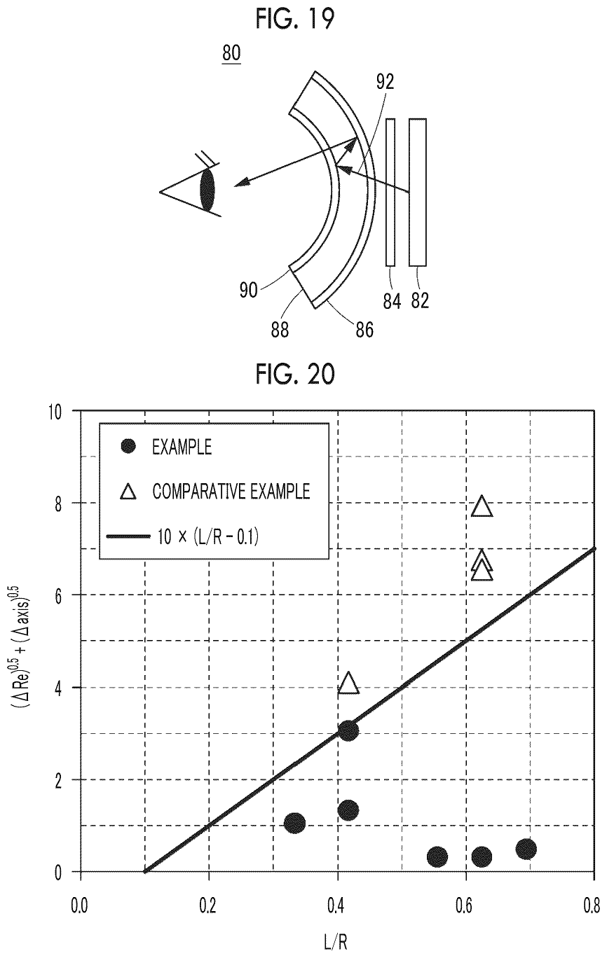

FIG. 19 is a schematic view showing an example of a configuration of the virtual reality display device.

A virtual reality display device 80 shown in FIG. 19 includes, from the right side in the drawing, an image display panel 82, a circularly polarizing plate 84, a half mirror 86, a lens 88, and a laminate 90 according to the embodiment of the present invention. The laminate 90 used in FIG. 19 has the same configuration as the above-described laminate 60A, and the optically anisotropic film 64 is disposed closer to the image display panel 82 than the absorptive polarizer 62.

The composite lens described above is configured by the laminate 90, the lens 88, and the half mirror 86 shown in FIG. 19.

In the virtual reality display device 80 shown in FIG. 19, a ray 92 emitted from an image display panel 82 is transmitted through a circularly polarizing plate 84 to be circularly polarized light, and is transmitted through a half mirror 86. Next, the ray transmits through the lens 88, is incident from the side of the cholesteric liquid crystal layer included in the laminate 90 according to the embodiment of the present invention, is reflected, transmits through the lens 88 again, is reflected by the half mirror 86 again, and is incident into the laminate 90 after being transmitted through the lens 88 again. In this case, the circular polarization state of the ray 92 does not change in a case where the ray 92 is reflected from the laminate 90, and changes to circularly polarized light having a direction opposite to that of the light incident on the laminate 90 in a case where the ray 92 is reflected from the half mirror 86. Therefore, the ray 92 is transmitted through the laminate 90, and visually recognized by a user. In addition, in a case where the ray 92 is reflected by the half mirror 86, since the half mirror 86 has a concave mirror shape, the image is magnified so that the user can visually recognize the magnified virtual image. The system described above is referred to as a reciprocating optical system, a folded optical system, or the like.

The optically anisotropic film according to the embodiment of the present invention, included in the laminate 90, functions as a so-called linear polarizer, and is used to prevent light which is unnecessarily transmitted through the cholesteric liquid crystal layer from being observed by the user of the virtual reality display device as leaked light.

In the optically anisotropic film according to the embodiment of the present invention, since the variation in the in-plane retardation and/or the in-plane slow axis direction of the convex curved surface portion is small, the occurrence of the light leakage can be further suppressed.

The image display panel 82 is, for example, a known image display panel (display panel) such as an organic electroluminescence display panel.

In the illustrated example, the image display panel 82 emits an image (image light) of unpolarized light. The unpolarized image emitted from the image display panel 82 passes through the circularly polarizing plate 84, and is converted into circularly polarized light.

### EXAMPLES

Hereinafter, features of the present invention will be described in more detail with reference to Examples and Comparative Examples. The materials, amounts used, proportions, treatment details, and treatment procedure shown in the following Examples can be appropriately changed without departing from the spirit and scope of the present invention. Accordingly, the scope of the present invention should not be construed as being limited by the specific examples given below.

### Example 1

### (Production of Optically Anisotropic Film A1)

### [Production of Substrate]

The following composition was put into a mixing tank, stirred, and heated at 90° C. for 10 minutes. Thereafter, the obtained composition was filtered through a filter paper having an average hole diameter of 34 μm and a sintered metal filter having an average hole diameter of 10 μm to prepare a dope. The concentration of solid contents of the dope was 23.5% by mass, the amount of the plasticizer added was a proportion to cellulose acylate, and the solvent of the dope was methylene chloride/methanol/butanol=81/18/1 (mass ratio).

Cellulose acylate dope

| | |
|---|---|
| Cellulose acylate (acetyl substitution degree: 2.86, viscosity average degree of polymerization: | |
| 310) | 100 parts by mass |
| Sugar ester compound 1 (Formula (S4) shown below) | 3.0 parts by mass |
| Sugar ester compound 2 (Formula (S5) shown below) | 1.0 part by mass |
| Silica particle dispersion (AEROSIL R972, manufactured by Nippon Aerosil Co., Ltd.) | 0.1 parts by mass |
| Solvent (methylene chloride/methanol/butanol) | 351.9 parts by mass |

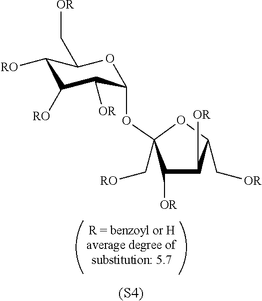

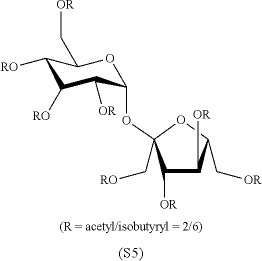

The dope produced above was cast using a drum film forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum, and then dried in a tenter device for 20 minutes at 30° C. to 40° C. during film transport, and the tenter device transported the web by clipping both ends of the web. Subsequently, the web was post-dried by zone heating while being rolled. The obtained web was subjected to knurling and then wound to obtain a cellulose acylate film 1.

In the obtained cellulose acylate film 1, a film thickness was 40 μm, an in-plane retardation Re(550) at a wavelength of 550 nm was 1 nm, and a thickness-direction retardation Rth(550) at a wavelength of 550 nm was 23 nm.

### [Production of Photo-Alignment Film 1]

The above-described cellulose acylate film 1 was continuously coated with a coating liquid E1 for forming a photo-alignment film, having the following formulation, with a wire bar. The support on which the coating film was formed was dried with hot air at 134° C. for 75 seconds, and the coating film was irradiated with polarized ultraviolet rays (8 mJ/cm², using an ultra-high pressure mercury lamp) to form a photo-alignment film 1. A film thickness of the photo-alignment film 1 was 0.5 μm.

Coating liquid E1 for forming photo-alignment film

| | | |
|---|---|---|
| Polymer PA-1 shown below | 100.00 | parts by mass |
| Acid generator PAG-1 shown below | 6.00 | parts by mass |
| DIPEA | 0.60 | parts by mass |
| Butyl acetate | 625.4 | parts by mass |
| Methyl ethyl ketone | 156.3 | parts by mass |

Polymer PA-1 [in the formula, the numerical value described in each repeating unit denotes the content (% by mass) of each repeating unit with respect to all repeating units; weight-average molecular weight: 45,000]

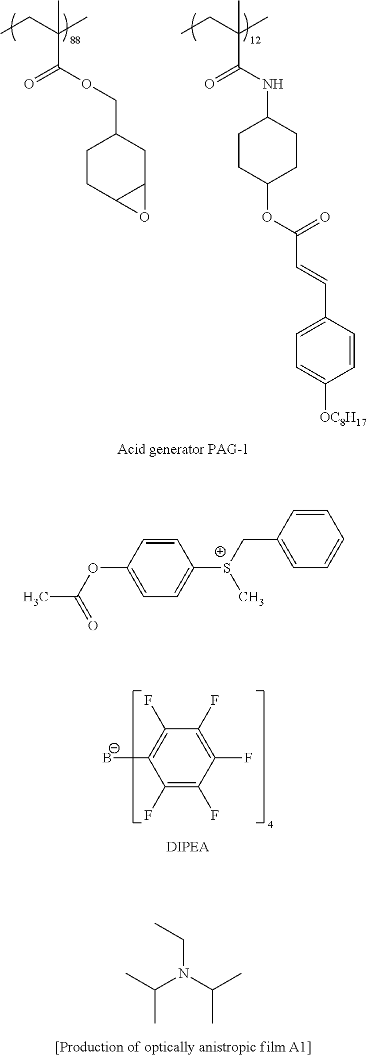

The above-described photo-alignment film 1 was coated with the following composition F1 using a bar coater. The coating film formed on the photo-alignment film 1 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A1 which was a positive A-plate. In this case, the ultraviolet irradiation was carried out in a state that a mask in which the ultraviolet transmittance linearly changed in a concentric circular shape with a diameter of 50 mm was disposed between the coating film and the high-pressure mercury lamp (see FIG. 10). A mask in which the transmittance of the central portion was 100% and the transmittance on the circumference was 0% was disposed during the irradiation at 60° C., and a mask in which the transmittance of the central portion was 0% and the transmittance on the circumference was 100% was disposed during the irradiation at 120° C.

The optically anisotropic film A1 corresponded to the above-described optical film having a change region.

The obtained optically anisotropic film A1 had a thickness of 3.5 μm and was a patterned retardation film in which an in-plane retardation continuously decreased in a concentric circular shape from the central portion toward a circumference of a circular having a diameter of 50 mm (see FIG. 1). Re(550) of the central portion was 180 nm, and Re(550) on the circumference of the circle having a diameter of 50 mm from the central portion was 142 nm. In addition, an average value of the in-plane retardations of the change region of the optically anisotropic film A1 at a wavelength of 550 nm was 160 nm. In addition, a relationship of Re(450)≤Re(550)≤Re(650) was satisfied at any position in the change region of the optically anisotropic film A1. In addition. Re(450)/Re(550) was 0.82 at any position in the change region of the optically anisotropic film A1.

Composition F1

| | |
|---|---|
| Polymerizable liquid crystal compound LA-1 shown below | 45.36 parts by mass |
| Polymerizable liquid crystal compound LA-2 shown below | 21.84 parts by mass |
| Polymerizable liquid crystal compound LA-3 shown below | 20.00 parts by mass |
| Polymerizable liquid crystal compound LA-4 shown below | 5.00 parts by mass |
| Mixture of polymerizable liquid crystal compounds LA-5 shown below | 7.80 parts by mass |
| Polymerization initiator PI-1 shown below | 0.50 parts by mass |
| Leveling agent T-1 shown below | 0.09 parts by mass |
| Cyclopentanone | 180.73 parts by mass |
| Methyl ethyl ketone | 53.98 parts by mass |

Polymerizable liquid crystal compound LA-1 (tBu represents a tertiary butyl group)

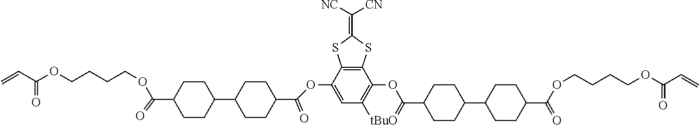 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

Polymerizable liquid crystal compound LA-2

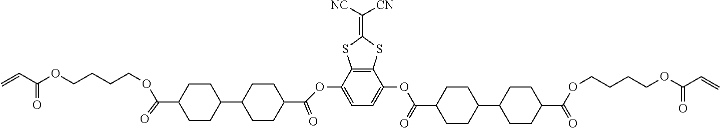 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

Polymerizable liquid crystal compound LA-3

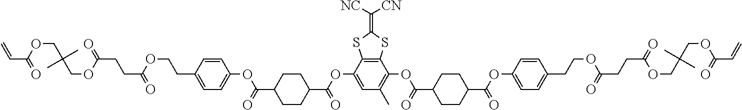 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

Polymerizable liquid crystal compound LA-4 (Me represents a methyl group)

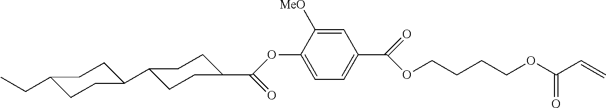 [SMILES: C=CC(=O)OCCCCOC(=O)c1ccc(OC(=O)C2CCC(C3CCC(CC)CC3)CC2)c(OC)c1]

Mixture of polymerizable liquid crystal compounds LA-5 (mixture of the following liquid crystal compounds (RA), (RB), and (RC) at a mass ratio of 84:14:2)
(RA)

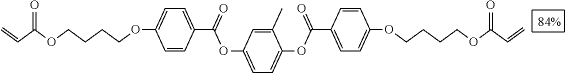 [SMILES: C=CC(=O)OCCCCOc1ccc(C(=O)Oc2ccc(OC(=O)c3ccc(OCCCCOC(=O)C=C)cc3)c(C)c2)cc1]

(RB)

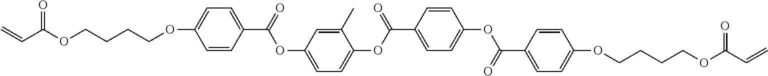 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1]

(RC)

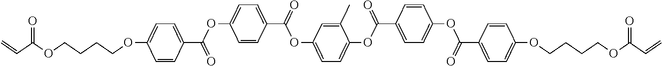 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]

Polymerization initiator PI-1

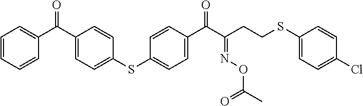 [SMILES: CC(=O)O/N=C(\CCSc1ccc(Cl)cc1)C(=O)c1ccc(Sc2ccc(C(=O)c3ccccc3)cc2)cc1]

Leveling agent T-1 [in the formula, the numerical value described in each repeating unit denotes the content (% by mass) of each repeating unit with respect to all repeating units; weight-average molecular weight: 25,000]

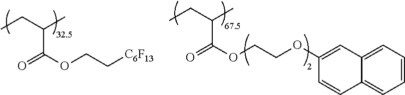

### (Production of Optically Anisotropic Film C1)

An optically anisotropic film C1 was produced with reference to a method described in paragraphs 0069 to 0077 of WO2018/174194A. The optically anisotropic film C1 had a thickness of 0.5 μm and Rth(550) of −60 nm.

### [Formation of Half Mirror on Lens]

A convex surface side of a lens (convex meniscus lens LE1076-A (diameter: 2 inches, focal length: 100 mm) manufactured by Thorlabs, Inc.) was subjected to aluminum vapor deposition so that the reflectivity was 40%, thereby forming a half mirror.

### (Production of Optical Laminate 1)

A pressure sensitive adhesive (SK-2057, manufactured by Soken Chemical & Engineering Co., Ltd.) was applied onto the above-described optically anisotropic film A1 opposite to the cellulose acylate film 1 side to form a pressure sensitive adhesive layer, the above-described optically anisotropic film C1 was bonded such that the pressure sensitive adhesive layer and the coating layer were in close contact with each other, and then the cellulose acylate film 1 and the photo-alignment film 1 were peeled off to obtain a laminate. Next, a pressure sensitive adhesive (SK-2057, manufactured by Soken Chemical & Engineering Co., Ltd.) was applied onto one surface of a linear polarization-type reflective polarizer (APF: 53 μm, manufactured by 3M) to form a pressure sensitive adhesive layer, the above-described laminate was bonded in a direction in which the optically anisotropic film A1 and the APF were in close contact with each other such that an average direction of in-plane slow axes of the optically anisotropic film A1 and a reflection axis of the linear polarization-type reflective polarizer formed an angle of 45°, and then the support was peeled off to obtain an optical laminate 1. The optical laminate 1 had the APF, the optically anisotropic film A1, and the optically anisotropic film C1 in this order.

### [Production of Formed Body 1]

The optical laminate 1 was set in a forming device. In this case, the optically anisotropic film C1 was disposed to be on the lower side. The forming surface in the forming device consisted of a box 1 and a box 2 partitioned by the optical laminate 1, and a meniscus lens (diameter: 50 mm, curvature radius of concave side: 40 mm) on which aluminum was vapor-deposited on the convex side as the mold was disposed in the box 1 located below the optical laminate 1 such that the concave surface was on the upper side. In addition, a transparent window was installed on the upper part of the box 2 on the upper side of the optical laminate 1, and an IR light source for heating the optical laminate 1 was installed on the outside of the forming device. Between the IR light source and the optical laminate 1, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the central portion of the patterned infrared reflection filter, the central portion of the mold, and the central portion of the pattern of the optically anisotropic film A1 were disposed to be at the same position in a case where the patterned infrared reflection filter was viewed from above. Next, each of the inside of the box 1 and the inside of the box 2 was evacuated to 0.1 atm or less by a vacuum pump. Next, as a step of heating the optical laminate 1, the optical laminate 1 was irradiated with infrared rays and heated until the central portion of the optical laminate 1 reached 108° C. and the end portion thereof reached 99° C. Next, as a step of pressing the optical laminate 1 against the mold to deform the optical laminate 1 along a shape of the mold, gas was allowed to flow into the box 2 from a gas cylinder to pressurize the optical laminate 1 to 300 kPa, and the optical laminate 1 was pressed against the mold. In this manner, a formed body 1 formed into a convex curved surface shape was obtained.

By the above-described procedure, the change region in the optically anisotropic film A1 was formed into a convex curved surface shape.

### Example 2

A formed body 2 was produced by the same method as in Example 1, except that the optically anisotropic film A1 was changed to the following optically anisotropic film A2, and the curvature radius of the meniscus lens during the curved surface forming was set to 45 mm.

### [Production of Optically Anisotropic Film A2]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A2 which was a positive A-plate. In this case, the ultraviolet irradiation was carried out in a state that a mask in which the ultraviolet transmittance linearly changed in a concentric circular shape with a diameter of 50 mm was disposed during the irradiation at 60° C. between the coating film and the high-pressure mercury lamp. In the irradiation at 60° C., a mask in which the transmittance of the central portion was 100% and the transmittance on the circumference was 0% was used. The mask was not disposed during the irradiation at 120° C.

The optically anisotropic film A2 corresponded to the above-described optical film having a change region.

The obtained optically anisotropic film A2 had a thickness of 3.6 μm and was a patterned retardation film in which Re continuously decreased in a concentric circular shape from the central portion toward a circumference of a circular having a diameter of 50 mm (see FIG. 1). Re(550) of the central portion was 171 nm, and Re(550) on the circumference of the circle having a diameter of 50 mm from the central portion was 142 nm. In addition, an average value of the in-plane retardations of the change region of the optically anisotropic film A2 at a wavelength of 550 nm was 156 nm. In addition, a relationship of Re(450)≤Re(550)≤Re(650) was satisfied at any position in the change region of the optically anisotropic film A2. In addition, Re(450)/Re(550) was 0.82 at any position in the change region of the optically anisotropic film A2.

### Example 3

A formed body 3 was produced by the same method as in Example 1, except that the optically anisotropic film A1 was changed to the following optically anisotropic film A3, and the curvature radius of the meniscus lens during the curved surface forming was set to 36 mm.

### [Production of Optically Anisotropic Film A3]

The above-described photo-alignment film 1 was coated with a composition F1 having the following formulation using a bar coater. The coating film formed on the photo-alignment film 1 was heated to 125° C. with hot air, cooled to 50° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A3 which was a positive A-plate. In this case, the ultraviolet irradiation was carried out in a state that a mask in which the ultraviolet transmittance linearly changed in a concentric circular shape with a diameter of 50 mm was disposed between the coating film and the high-pressure mercury lamp. A mask in which the transmittance of the central portion was 100% and the transmittance on the circumference was 0% was disposed during the irradiation at 50° C., and a mask in which the transmittance of the central portion was 0% and the transmittance on the circumference was 100% was disposed during the irradiation at 120° C.

The optically anisotropic film A3 corresponded to the above-described optical film having a change region.

The obtained optically anisotropic film A3 had a thickness of 3.5 μm and was a patterned retardation film in which Re continuously decreased in a concentric circular shape from the central portion toward a circumference of a circular having a diameter of 50 mm (see FIG. 1). Re(550) of the central portion was 193 nm, and Re(550) on the circumference of the circle having a diameter of 50 mm from the central portion was 142 nm. In addition, an average value of the in-plane retardations of the change region of the optically anisotropic film A3 at a wavelength of 550 nm was 166 nm. In addition, a relationship of Re(450)≤Re(550)≤Re(650) was satisfied at any position in the change region of the optically anisotropic film A3. In addition, Re(450)/Re(550) was 0.82 at any position in the change region of the optically anisotropic film A3.

### Example 4

A formed body 4 was produced by the same method as in Example 1, except that the optically anisotropic film A1 was changed to the following optically anisotropic film A4, and the ring-shaped patterned infrared reflecting filter was not disposed during the formation of the curved surface.

### [Production of Wire Grid Polarizer 1]

A wire grid polarizer 1 was produced with reference to JP2012-118438A. In a case where the wire grid 1 transmitted only polarized light in a specific direction and the photo-alignment film was irradiated through the wire grid polarizer 1, an alignment film having an alignment restriction force for generating the in-plane slow axis direction of the change region as shown in FIG. 8 could be obtained.

### [Production of Photo-Alignment Film 2]

The above-described coating liquid E1 for forming a photo-alignment film was continuously applied onto the above-described cellulose acylate film 1 with a wire bar, and the support on which the coating film was formed was dried with hot air at 134° C. for 75 seconds. Subsequently, ultraviolet rays generated using an ultra-high pressure mercury lamp were collimated using a collimating lens, and then polarized through the above-described wire grid polarizer 1, and the coating film was irradiated with polarized ultraviolet rays (8 mJ/cm²) to form a photo-alignment film 2. A film thickness of the photo-alignment film 2 was 0.5 μm.

### [Production of Optically Anisotropic Film A4]

The above-described photo-alignment film 2 was coated with the above-described composition F1 using a bar coater. The coating film formed on the photo-alignment film 2 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A4 which was a positive A-plate. In this case, the ultraviolet irradiation was carried out in a state that a mask in which the ultraviolet transmittance linearly changed in a concentric elliptical shape with a diameter of 50 mm was disposed between the coating film and the high-pressure mercury lamp. A mask in which the transmittance of the central portion was 60% and the transmittance on the circumference was 30% was disposed during the irradiation at 60° C., and a mask in which the transmittance of the central portion was 40% and the transmittance on the circumference was 70% was disposed during the irradiation at 120° C.

The optically anisotropic film A4 corresponded to the above-described optical film having a change region.

The obtained optically anisotropic film A4 had a thickness of 3.5 μm and was a patterned retardation film in which Re continuously decreased in a concentric elliptical shape from the central portion toward a circumference of a circular having a diameter of 50 mm (see FIG. 7). In addition, an average value of the in-plane retardations of the change region of the optically anisotropic film A4 at a wavelength of 550 nm was 160 nm. In addition, a relationship of Re(450)≤Re(550)≤Re(650) was satisfied at any position in the change region of the optically anisotropic film A4. In addition, Re(450)/Re(550) was 0.82 at any position in the change region of the optically anisotropic film A4.

### Example 5

A formed body 5 was produced by the same method as in Example 4, except that the following photo-alignment film 3 was used instead of the photo-alignment film 2 used in the optically anisotropic film A4.

An average value of the in-plane retardations of the change region of the optically anisotropic film A5 obtained in Example 5 at a wavelength of 550 nm was 160 nm. The optically anisotropic film A5 corresponded to the above-described optical film having a change region.

### [Production of Photo-Alignment Film 3]

The above-described cellulose acylate film 1 was continuously coated with the above-described coating liquid E1 for forming a photo-alignment film using a wire bar. The support on which the coating film was formed was dried with hot air at 134° C. for 75 seconds, ultraviolet rays generated using an ultra-high pressure mercury lamp were collimated using a collimating lens, and then polarized through a wire grid which transmits only one direction of polarized light, and the coating film was irradiated with polarized ultraviolet rays (8 mJ/cm², using an ultra-high pressure mercury lamp) to form a photo-alignment film 3 (see FIGS. 11 and 12). In this case, the coating film was irradiated with polarized light in a state that a mask having a donut-shaped light shielding portion with an outer diameter of 75 mm and an inner diameter of 25 mm was disposed between the coating film and the wire grid. In this case, a distance between the coating film and the mask was 34 mm, a distance between the mask and the wire grid was 34 mm, and a distance between the wire grid and the mercury lamp was 10 mm. The photo-alignment film 3 was an alignment film having an alignment restriction force for generating the in-plane slow axis direction of the change region as shown in FIG. 8. A film thickness of the photo-alignment film 3 was 0.5 μm.

### Example 6

A formed body 6 was produced by the same method as in Example 4, except that the optically anisotropic film A4 was changed to the following optically anisotropic film A6, and the curvature radius of the meniscus lens during the curved surface forming was set to 60 mm. [Production of optically anisotropic film A6]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A6 which was a positive A-plate. In this case, the ultraviolet irradiation was carried out in a state that a mask in which the ultraviolet transmittance linearly changed in a concentric elliptical shape with a diameter of 50 mm was disposed between the coating film and the high-pressure mercury lamp. A mask in which the transmittance of the central portion was 20% and the transmittance on the circumference was 10% was disposed during the irradiation at 60° C., and a mask in which the transmittance of the central portion was 80% and the transmittance on the circumference was 90% was disposed during the irradiation at 120° C.

The optically anisotropic film A6 corresponded to the above-described optical film having a change region.

The obtained optically anisotropic film A6 had a thickness of 3.5 μm and was a patterned retardation film in which Re continuously decreased in a concentric elliptical shape from the central portion toward a circumference of a circular having a diameter of 50 mm (see FIG. 7). In addition, an average value of the in-plane retardations of the change region of the optically anisotropic film A6 at a wavelength of 550 nm was 149 nm. In addition, a relationship of Re(450)≤Re(550)≤Re(650) was satisfied at any position in the change region of the optically anisotropic film A6. In addition, Re(450)/Re(550) was 0.82 at any position in the change region of the optically anisotropic film A6.

### Example 7

A formed body 7 was produced by the same method as in Example 6, except that the optically anisotropic film A6 was changed to the following optically anisotropic film A7.

### [Production of Optically Anisotropic Film A7]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A7 which was a positive A-plate. In this case, the ultraviolet irradiation was carried out in a state that a mask in which the ultraviolet transmittance linearly changed in a concentric elliptical shape with a diameter of 50 mm was disposed between the coating film and the high-pressure mercury lamp. A mask in which the transmittance of the central portion was 70% and the transmittance on the circumference was 30% was disposed during the irradiation at 60° C., and a mask in which the transmittance of the central portion was 30% and the transmittance on the circumference was 60% was disposed during the irradiation at 120° C.

The optically anisotropic film A7 corresponded to the above-described optical film having a change region.

The obtained optically anisotropic film A7 had a thickness of 3.1 μm and was a patterned retardation film in which Re continuously decreased in a concentric elliptical shape from the central portion toward a circumference of a circular having a diameter of 50 mm (see FIG. 7). In addition, an average value of the in-plane retardations of the change region of the optically anisotropic film A7 at a wavelength of 550 nm was 149 nm. In addition, a relationship of Re(450)≤Re(550)≤Re(650) was satisfied at any position in the change region of the optically anisotropic film A7. In addition, Re(450)/Re(550) was 0.82 at any position in the change region of the optically anisotropic film A7.

### Example 8

A formed body 8 was produced by the same method as in Example 6, except that the optically anisotropic film A6 was changed to the following optically anisotropic film A8.

### [Production of Optically Anisotropic Film A8]

The above-described photo-alignment film 3 was coated with the above-described composition F1 using a bar coater. The coating film formed on the photo-alignment film 3 was heated to 125° C. with hot air, cooled to 60° C., irradiated with ultraviolet rays having a wavelength of 365 nm with an illuminance of 80 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A8 which was a positive A-plate.

The optically anisotropic film A8 corresponded to the above-described optical film having a change region.

A thickness of the obtained optically anisotropic film A8 was 3.2 μm, and an average value of the in-plane retardations of the change region of the optically anisotropic film A8 at a wavelength of 550 nm was 151 nm. In addition, a relationship of Re(450)≤Re(550)≤Re(650) was satisfied at any position in the change region of the optically anisotropic film A8. In addition, Re(450)/Re(550) was 0.82 at any position in the change region of the optically anisotropic film A8.

### Example 9

A formed body 9 was produced by the same method as in Example 4, except that the optically anisotropic film A4 was changed to the following optically anisotropic film A9, and the curvature radius of the meniscus lens during the curved surface forming was set to 75 mm.

### [Production of Optically Anisotropic Film A9]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 200 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A9 which was a positive A-plate layer. In this case, the ultraviolet irradiation was carried out in a state that a mask in which the ultraviolet transmittance linearly changed in a concentric elliptical shape with a diameter of 50 mm was disposed between the coating film and the high-pressure mercury lamp. A mask in which the transmittance of the central portion was 15% and the transmittance on the circumference was 10% was disposed during the irradiation at 60° C., and a mask in which the transmittance of the central portion was 85% and the transmittance on the circumference was 90% was disposed during the irradiation at 120° C.

The obtained optically anisotropic film A9 had a thickness of 3.5 μm and was a patterned retardation film in which Re continuously decreased in a concentric elliptical shape from the central portion toward a circumference of a circular having a diameter of 50 mm (see FIG. 7). In addition, an average value of the in-plane retardations of the change region of the optically anisotropic film A9 at a wavelength of 550 nm was 146 nm. In addition, a relationship of Re(450)≤Re(550)≤Re(650) was satisfied at any position in the change region of the optically anisotropic film A9. In addition, Re(450)/Re(550) was 0.82 at any position in the change region of the optically anisotropic film A9.

### Comparative Example 1

A formed body 10 was produced by the same method as in Example 4, except that the optically anisotropic film A4 was changed to the following optically anisotropic film A10. [Production of optically anisotropic film A10]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 80 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A10 which was a positive A-plate.

A thickness of the obtained optically anisotropic film A10 was 3.5 μm, and an average value of the in-plane retardations at a wavelength of 550 nm was 166 nm. In addition, a relationship of Re(450)≤Re(550)≤Re(650) was satisfied at any position in the change region of the optically anisotropic film A10. In addition, Re(450)/Re(550) was 0.82 at any position in the change region of the optically anisotropic film A10.

### Comparative Example 2

A formed body 11 was produced by the same method as in Example 1, except that the optically anisotropic film A1 was changed to the following optically anisotropic film A11.

### [Production of Optically Anisotropic Film A11]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 80 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A11 which was a positive A-plate.

A thickness of the obtained optically anisotropic film A11 was 3.8 μm, and an average value of the in-plane retardations at a wavelength of 550 nm was 180 nm. In addition, a relationship of Re(450)≤Re(550)≤Re(650) was satisfied at any position in the change region of the optically anisotropic film A11. In addition, Re(450)/Re(550) was 0.82 at any position in the change region of the optically anisotropic film A11.

### Comparative Example 3

A formed body 12 was produced by the same method as in Example 1, except that the optically anisotropic film A1 was changed to the following optically anisotropic film A12, and the curvature radius of the meniscus lens during the curved surface forming was set to 60 mm.

### [Production of Optically Anisotropic Film A12]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 80 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A12 which was a positive A-plate.

A thickness of the obtained optically anisotropic film A12 was 3.3 μm, and an average value of the in-plane retardations at a wavelength of 550 nm was 156 nm. In addition, a relationship of Re(450)≤Re(550)≤Re(650) was satisfied at any position in the change region of the optically anisotropic film A12. In addition, Re(450)/Re(550) was 0.82 at any position in the change region of the optically anisotropic film A12.

### Comparative Example 4

A formed body 13 was produced by the same method as in Example 1, except that the optically anisotropic film A1 was changed to the following optically anisotropic film A13, and the ring-shaped patterned infrared reflection filter used during the formation of the curved surface was changed to a circular patterned infrared reflection filter obtained by cutting out a cholesteric liquid crystal layer which reflects infrared light in a wavelength range of 2.2 μm to 3.0 μm with a reflectivity of approximately 50% into a circle having a diameter of 2.5 cm.

### [Production of Optically Anisotropic Film A13]

The above-described photo-alignment film 1 was coated with the above-described composition F1 using a bar coater. The coating film formed on the photo-alignment film 1 was heated to 125° C. with hot air, cooled to 60° C., irradiated with ultraviolet rays having a wavelength of 365 nm with an illuminance of 80 mJ/cm² using a high-pressure mercury lamp in a nitrogen atmosphere, and continuously irradiated with ultraviolet rays with an illuminance of 200 mJ/cm² while being heated at 120° C., so that the alignment of the liquid crystal compound was immobilized, thereby producing an optically anisotropic film A13 which was a positive A-plate.

A thickness of the obtained optically anisotropic film A13 was 3.4 μm, and an average value of the in-plane retardations at a wavelength of 550 nm was 159 nm. In addition, a relationship of Re(450)≤Re(550)≤Re(650) was satisfied at any position in the change region of the optically anisotropic film A13. In addition, Re(450)/Re(550) was 0.82 at any position in the change region of the optically anisotropic film A13.

### <Optical Evaluation of Optically Anisotropic Film>

A formed body having a convex curved surface portion was produced according to the same procedure as in each of Examples and Comparative Examples, except that the pressure sensitive adhesive to be formed on the APF was changed to a water-soluble pressure sensitive adhesive SK Dyne 1193 (manufactured by Soken Chemical & Engineering Co., Ltd.), the meniscus lens during the curved surface forming was changed to a plano-convex lens made of optical glass, and the optically anisotropic film C1 was not bonded. The obtained formed body was immersed in water for 8 hours to dissolve the water-soluble pressure sensitive adhesive and peel off the APF, and the in-plane retardation and the in-plane slow axis of the convex curved surface portion of the obtained optically anisotropic film were measured with a two-dimensional birefringence evaluation system WPA-200. The optically anisotropic films produced as described above were produced under the same forming conditions as the optically anisotropic films in the formed bodies 1 to 13, and had the same shapes. That is, the optically anisotropic films produced as described above exhibited the same optical characteristics as the optically anisotropic films in the formed bodies 1 to 13. Table 1 shows the measurement results of ΔRe and Δaxis described above.

During the measurement, a plano-convex lens (made of optical glass) having the same diameter and curvature radius as the plano-concave lens used during the curved surface forming was superposed so that the convex surface side was in contact with the concave surface of the formed body, thereby canceling the effect of refraction by the concave surface of the formed body and enabling the measurement of the in-plane retardation and the in-plane slow axis of the optically anisotropic film.

### [Production of Composite Lens]

The APF side of the formed bodies 1 to 13 obtained above and the photo-alignment film side of the following absorptive polarizer film 1S were bonded to each other with a pressure sensitive adhesive. However, the APF and the light absorption anisotropic layer were laminated such that the transmission axis of the APF and the transmission axis of the light absorption anisotropic layer matched each other. In this manner, composite lenses 1 to 13 consisting of half mirror/meniscus lens/positive C-plate/pressure sensitive adhesive/optically anisotropic film according to the embodiment of the present invention/pressure sensitive adhesive layer/APF/pressure sensitive adhesive layer/absorptive polarizer were obtained.

### [Production of Absorptive Polarizer Film 1S Including Light Absorption Anisotropic Layer]

### [Production of Substrate]

A cellulose acylate film A2 was produced by the same method as that for the cellulose acylate film 1, except that the film thickness was set to 60 μm.

### [Formation of Photo-Alignment Film B1]

A cellulose acylate film A2 described below was continuously coated with a composition B1 for forming a photo-alignment film described below with a wire bar. The support on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B1, thereby obtaining a triacetyl cellulose (TAC) film with the photo-alignment film. A film thickness of the photo-alignment film B1 was 1.5 μm.

Formulation of composition B1 for forming photo-alignment film

| | |
|---|---|
| Photo-alignment compound PA-1 shown below | 100.00 parts by mass |
| EPICLON N-695 (manufactured by DIC Corporation) | 55.74 parts by mass |
| jER YX7400 (manufactured by Mitsubishi Chemical Corporation) | 18.75 parts by mass |
| Polymerizable polymer PA-2 shown below | 8.01 parts by mass |
| Thermal cationic polymerization initiator PAG-1 shown below | 16.75 parts by mass |
| Stabilizer DIPEA shown below | 1.06 parts by mass |
| Butyl acetate | 1230.49 parts by mass |

Photo-alignment compound PA-1
(in the formula, the numerical value described in each repeating unit denotes the content (% by mass) of each repeating unit with respect to all repeating units; weight-average molecular weight: 32,000)

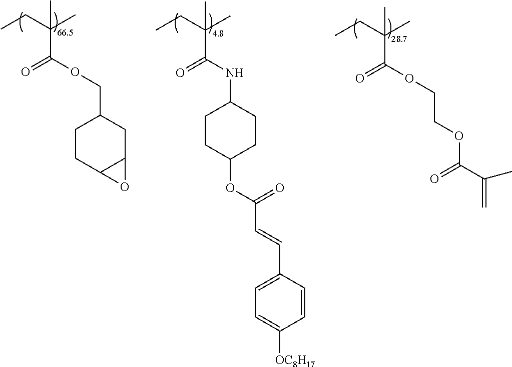

Thermal cationic polymerization initiator PAG-1

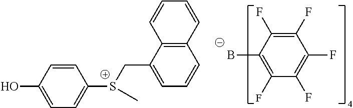

Stabilizer DIPEA

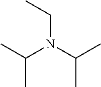

Polymerizable polymer PA-2 [weight-average molecular weight: 18,000]

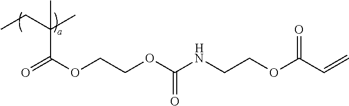

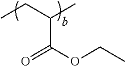

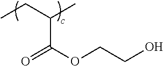

a/b/c = 89/10/1

### [Formation of Light Absorption Anisotropic Film C1]

A coating film was formed by continuously coating the obtained photo-alignment film B1 with a composition C1 for forming a light absorption anisotropic film, having the following formulation, with a wire bar.

Next, the coating film was heated at 130° C. for 15 seconds, and then cooled to room temperature (23° C.). Next, the coating film was heated at 75° C. for 10 seconds, and cooled to room temperature again.

Thereafter, the coating film was irradiated with a light emitting diode (LED) lamp (central wavelength: 365 nm) under an irradiation condition of 300 mJ, thereby forming a light absorption anisotropic film (polarizer) C1 (thickness: 1.8 μm) on the photo-alignment film B1.

An absorption axis of the light absorption anisotropic film C1 was in the plane of the light absorption anisotropic film C1, and was orthogonal to a width direction of the cellulose acylate film A2.

Formulation of composition C6 for forming light absorption anisotropic film

| | |
|---|---|
| Dichroic substance Dye-C1 shown below | 0.19 parts by mass |
| Dichroic substance Dye-C2 shown below | 0.58 parts by mass |
| Dichroic substance Dye-M1 shown below | 0.19 parts by mass |
| Dichroic substance Dye-Y2 shown below | 0.03 parts by mass |
| Liquid crystal compound L-1 shown below | 3.27 parts by mass |
| Liquid crystal compound L-2 shown below | 0.70 parts by mass |
| Liquid crystal compound L-3 shown above | 0.70 parts by mass |
| Adhesion improver A-1 shown above | 0.06 parts by mass |
| Polymerization initiator IRGACURE OXE-02 (manufactured by BASF) | 0.18 parts by mass |
| Surfactant F-3 shown below | 0.009 parts by mass |
| Cyclopentanone | 91.75 parts by mass |
| Benzyl alcohol | 2.35 parts by mass |

Dichroic substance Dye-C1 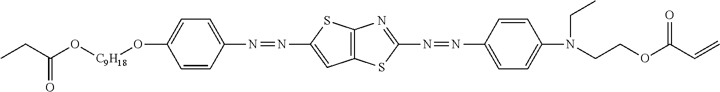
Dichroic substance Dye-C2 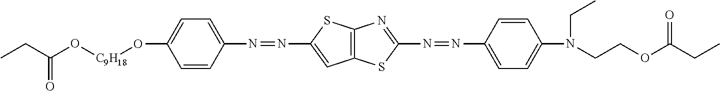
Dichroic substance Dye-M1 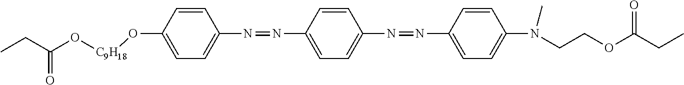
Dichroic substance Dye-Y2

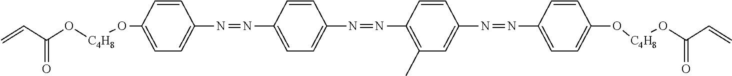

### Liquid Crystal Compound L-1

(in the formula, the numerical values (“59”, “15”, and “26”) described in each repeating unit denote the content (% by mass) of each repeating unit with respect to all repeating units; weight-average molecular weight: 18,000)

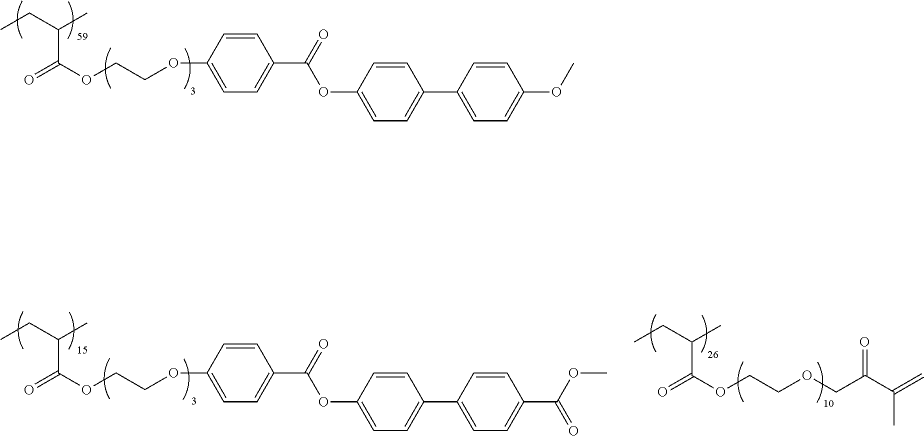

### Liquid Crystal Compound L-2 (Mixture of the Following Liquid Crystal Compounds (RA), (RB), and (RC) at a Mass Ratio of 84:14:2)

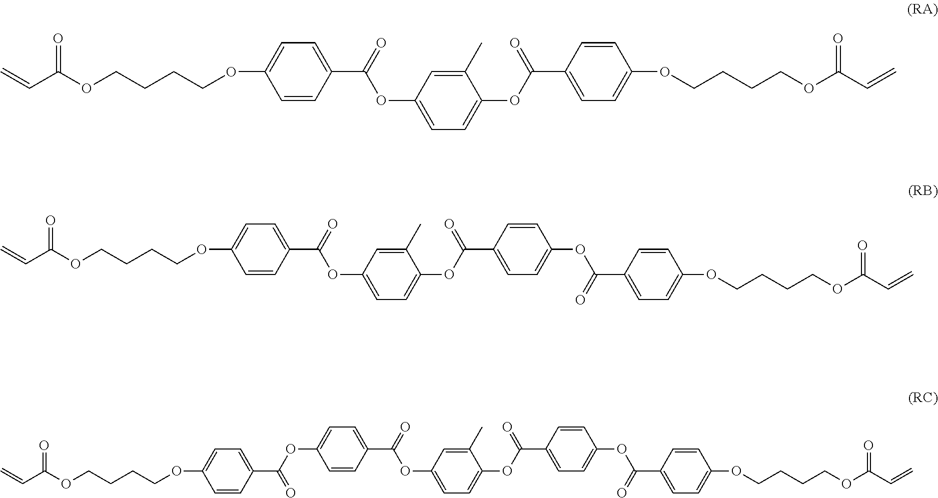

### Liquid Crystal Compound L-3

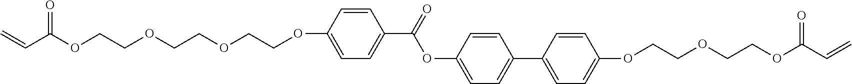 [SMILES: C=CC(=O)OCCOCCOCCOc1ccc(C(=O)Oc2ccc(-c3ccc(OCCOCCOC(=O)C=C)cc3)cc2)cc1]

### Adhesion Improver A-1

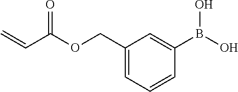

### Surfactant F-3

(in the formula, the numerical value described in each repeating unit denotes the content (% by mass) of each repeating unit with respect to all repeating units; Ac represents —C(O)CH₃; and weight-average molecular weight: 15,000)

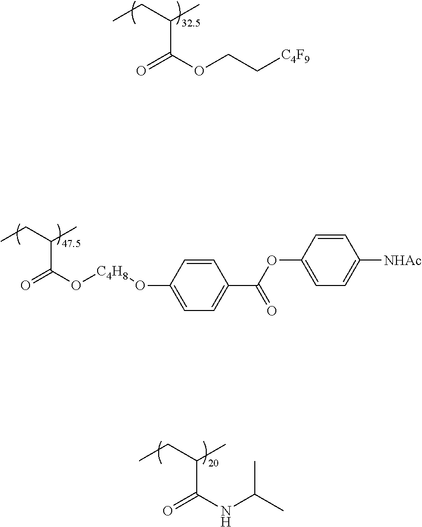

### [Formation of Protective Layer D1]

The light absorption anisotropic film C1 was continuously coated with a coating liquid D2 having the following formulation with a wire bar.

Thereafter, the coating film was dried with hot air at 80° C. for 5 minutes and irradiated with light at an irradiation amount of 300 mJ using a light emitting diode (LED) lamp (central wavelength: 365 nm) to obtain a laminate with the protective layer D1 consisting of polyvinyl alcohol (PVA) and having a thickness of 0.6 μm was formed, that is, an absorptive polarizer film 1 in which the cellulose acylate film 1 (substrate), the photo-alignment film B1, the light absorption anisotropic film C1, and the protective layer D1 were provided adjacent to each other in this order.

Formulation of coating liquid D1 for forming protective layer

| | | |
|---|---|---|
| Modified polyvinyl alcohol shown below | 3.31 | parts by mass |
| Initiator IRGACURE 2959 (manufactured | 0.17 | parts by mass |
| by BASF) | | |
| Glutaraldehyde | 0.07 | parts by mass |
| Pyridinium paratoluene sulfonate | 0.05 | parts by mass |
| Surfactant F-9 shown below | 0.0018 | parts by mass |
| Water | 74.0 | parts by mass |
| Ethanol | 22.4 | parts by mass |

Modified polyvinyl alcohol (in the formulae, the numerical value described in each repeating unit represents a content (% by mass) of each repeating unit with respect to all repeating units; weight-average molecular weight: 14,000)

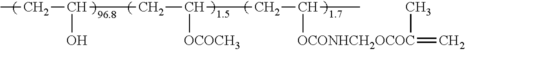

### Surfactant F-9

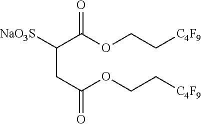

[Production of Absorptive Polarizer Film 1S Formed into Curved Surface]

The protective layer side of the absorptive polarizer film 1 was bonded to the PMMA film through a pressure sensitive adhesive sheet, only the substrate was peeled off to obtain an absorptive polarizer film 2, and the absorptive polarizer film 2 was set in a forming device. At this time, the PMMA film side was positioned on the upper side. The forming space in the forming device consisted of a box 1 and a box 2 partitioned by the absorptive polarizer film 2, and a meniscus lens (diameter: 50 mm) as a mold was disposed in the box 1 located below the absorptive polarizer film 2 such that the concave surface was on the upper side. In this case, the curvature radius of the concave surface side was set to be the same as the curvature radius of each of the bonded formed bodies 1 to 13. In addition, a transparent window was installed on the upper portion of the box 2 above the absorptive polarizer film 2, and an IR light source for heating the absorptive polarizer film 2 was installed outside the window. Between the IR light source and the absorptive polarizer film 2, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the absorptive polarizer film 2, the absorptive polarizer film 2 was irradiated with infrared rays and heated until the center portion of the absorptive polarizer film 2 reached 108° C. and the end portion thereof reached 99° C. Since the glass transition temperature Tg of the PMMA film used as the support was 105° C., it was intended that the central portion would be more likely to stretch and the end part would be less likely to stretch during the forming. Next, as a step of pressing the absorptive polarizer film 2 against the mold to deform the absorptive polarizer film 2 along a shape of the mold, gas was allowed to flow into the box 2 from a gas cylinder to pressurize the absorptive polarizer film 2 to 300 kPa, and the absorptive polarizer film 2 was pressed against the mold. Finally, the absorptive polarizer film 2 was removed from the lens as the mold to obtain an absorptive polarizer film 1S formed into a curved surface.

### [Production of Virtual Reality Display Device]

A virtual reality display device “Huawei VR Glass” manufactured by Huawei Technologies Co., Ltd., which was a virtual reality display device for which a reciprocating optical system was employed, was disassembled, and all composite lenses were taken out. Instead of the composite lenses, the composite lenses 1 to 13 were incorporated into the main body such that the light absorption anisotropic layer side was on the eye side, thereby producing virtual reality display devices 1 to 13.

### <Evaluation of Light Leakage>

In the produced virtual reality display devices 1 to 13, a black-and-white checkered pattern was displayed on an image display panel, and a degree of light leakage was visually evaluated according to the following three stages. In a case where there was the light leakage, double images were visually recognized, and a contrast of the corresponding portion was lowered. An evaluation of B or higher is preferable.
A: double images were not visible at all.
B: double images were slightly visible but not noticeable.
C: clear double images were observed.

The results are shown in Table 1.

In the column of “Re” in Table 1, a case where the above-described requirement of “the in-plane retardation gradually decreased from the center of the change region toward the outer direction” was satisfied is indicated as “A”, and a case where the requirement was not satisfied is indicated as “B”.

In the column of “Axis” in Table 1, a case where the requirement of “the in-plane slow axis direction at the center of the change region was parallel to the average direction of in-plane slow axes, and the in-plane slow axis direction on the third reference line gradually increased from the center of the change region toward the outer direction” was satisfied is indicated as “A”, and a case where the requirement was not satisfied is indicated as “B”.

In Table 1, the column of “Deviation angle” indicates an angle formed by the in-plane slow axis at the center of the change region and the in-plane slow axis at the position on the third reference line and the peripheral edge of the change region.

In the column of “Requirement 1 and requirement 2” in Table 1, a case where both the above-described requirement 1 and requirement 2 were satisfied is indicated as “A”, and a case where any one of the requirement 1 or the requirement 2 was not satisfied or a case where both the requirement 1 and the requirement 2 were not satisfied is indicated as “B”.

In Table 1, the column of “Curvature radius R (mm)” and the column of “Lens radius L (mm)” respectively indicate the minimum curvature radius (mm) of the convex curved surface portion and the half value (mm) of the equivalent circle diameter of the convex curved surface portion.

In Table 1, the column of “ΔRe (nm)” indicates the difference (nm) of the largest in-plane retardation among the differences of in-plane retardations at the two positions on the convex curved surface portion described above at a wavelength of 550 nm.

In Table 1, the column of “Δaxis (°)” indicates the largest angle (°) among the angles formed by the in-plane slow axes at two positions on the convex curved surface portion in a case of being observed from the normal direction of the tangent plane at the apex of the convex curved surface portion.

In the column of “Expression (1)” in Table 1, a case where the above-described requirement of the expression (1) was satisfied is indicated as “A”, and a case where the above-described requirement of the expression (1) was not satisfied is indicated as “B”.

In the column of “Expression (2)” in Table 1, a case where the above-described requirement of the expression (2) was satisfied is indicated as “A”, and a case where the above-described requirement of the expression (2) was not satisfied is indicated as “B”.

In addition, the change regions of the optical films of Examples 4, 5, and 8 satisfied the above-described various requirements. More specific method thereof is as follows.

In the change regions of the optical films of Examples 4, 5, and 8, the point P1 and the point P2 were provided, and the angle A1 formed by the in-plane slow axis at the point P1 and the first reference line and the angle A2 formed by the in-plane slow axis at the point P2 and the first reference line were the same.

In addition, in the change regions of the optical films of Examples 4, 5, and 8, the points P3 and P4 were provided, and the angle A3 formed by the in-plane slow axis at the point P3 and the second reference line and the angle A4 formed by the in-plane slow axis at the point P4 and the second reference line were the same.

In addition, in the change regions of the optical films of Examples 4, 5, and 8, the in-plane slow axis directions at the respective positions on the first reference line and the second reference line were parallel to the in-plane slow axis direction at the center of the change region.

In addition, in the change regions of the optical films of Examples 4, 5, and 8, in a case where two lines forming an angle of 22.5° with the first reference line and the third reference line are defined as a fourth reference line, the angle (acute angle) between the in-plane slow axis at each position on the fourth reference line and the fourth reference line gradually increased from the center C toward the outer direction. In addition, in the change regions of the optical films of Examples 4, 5, and 8, in a case where two lines forming an angle of 22.5° with the second reference line and the third reference line are defined as a fifth reference line, the angle (acute angle) between the in-plane slow axis at each position on the fifth reference line and the fifth reference line gradually increased from the center C toward the outer direction.

In addition, in the change regions of the optical films of Examples 4, 5, and 8, the two positions which were located within the two adjacent divided regions surrounded by the first reference line and the third reference lines, were located on the two fourth reference lines described above, and faced each other across the first reference line corresponded to the points P1 and P2 satisfying the above-described requirement 1 at any position. In addition, in the change regions of the optical films of Examples 4, 5, and 8, the two positions which were located within the two adjacent divided regions surrounded by the second reference line and the third reference lines, were located on the two fifth reference lines described above, and faced each other across the second reference line corresponded to the points P3 and P4 satisfying the above-described requirement 2 at any position.

In addition, in the change regions of the optical films of Examples 4, 5, and 8, the inclination of the in-plane slow axis, with respect to the first reference line, at each position in the two adjacent divided regions (the combination of the divided region R1 and the divided region R2 and the combination of the divided region R5 and the divided region R6 in FIG. 8) surrounded by the first reference line and the third reference lines in the change region increased as the distance from the first reference line increased. In addition, in the change regions of the optical films of Examples 4, 5, and 8, the inclination of the in-plane slow axis, with respect to the second reference line, at each position in the two adjacent divided regions (the combination of the divided region R3 and the divided region R4 and the combination of the divided region R7 and the divided region R8 in FIG. 8) surrounded by the second reference line and the third reference lines in the change region decreased as the distance from the second reference line increased.

TABLE 1

| | | | | | During | | | | | | | | |
|---|---|---|---|---|---|---|---|---|---|---|---|---|---|
| | | | | | processing | | | | | | | | |
| | Optical film having change region | | | | Patterned | Curved surface shape | | | Optically anisotropic | | | | |
| | | | Deviation | Requirement | infrared | Curvature | Lens | | film after forming | | Expres- | Expres- | |
| | | | angle | 1 and require- | reflecting | radius | radius | | ΔRe | Δaxis | sion | sion | Evalua- |
| | Re | Axis | (°) | ment 2 | filter | R (mm) | L (mm) | L/R | (nm) | (°) | (1) | (2) | tion |
| Example 1 | A | B | 0 | B | Presence | 40 | 25 | 0.63 | 0.0 | 0.1 | A | A | A |
| Example 2 | A | B | 0 | B | Presence | 45 | 25 | 0.56 | 0.0 | 0.1 | A | A | A |
| Example 3 | A | B | 0 | B | Presence | 36 | 25 | 0.69 | 0.0 | 0.2 | A | A | A |
| Example 4 | A | A | 2 | A | Absence | 40 | 25 | 0.63 | 0.0 | 0.1 | A | A | A |
| Example 5 | A | A | 2 | A | Absence | 40 | 25 | 0.63 | 0.0 | 0.1 | A | A | A |
| Example 6 | A | B | 0 | B | Absence | 60 | 25 | 0.42 | 0.0 | 1.8 | A | A | B |
| Example 7 | A | B | 0 | B | Absence | 60 | 25 | 0.42 | 0.0 | 1.8 | A | A | B |
| Example 8 | B | A | 1 | A | Absence | 60 | 25 | 0.42 | 8.5 | 0.0 | A | A | B |
| Example 9 | A | B | 0 | B | Absence | 75 | 25 | 0.33 | 0.0 | 1.1 | A | A | A |
| Comparative | B | B | 0 | B | Absence | 40 | 25 | 0.63 | 21.7 | 4.4 | B | A | C |
| Example 1 | | | | | | | | | | | | | |
| Comparative | B | B | 0 | B | Presence | 40 | 25 | 0.63 | 38.0 | 0.1 | B | A | C |
| Example 2 | | | | | | | | | | | | | |
| Comparative | B | B | 0 | B | Presence | 60 | 25 | 0.42 | 14.4 | 0.1 | B | A | C |
| Example 3 | | | | | | | | | | | | | |
| Comparative | B | B | 0 | B | Presence | 40 | 25 | 0.63 | 29.0 | 6.5 | B | A | C |
| Example 4 | | | | | | | | | | | | | |

As shown in the table, it was found that the optically anisotropic film according to the embodiment of the present invention exhibited a desired effect.

In addition, it was also found that an optically anisotropic film exhibiting a desired effect could be formed by using the optical film according to the embodiment of the present invention, having the change region.

From the comparison of Examples 1 to 9, it was found that a more excellent effect was obtained in a case where ΔRe was 0 to 5 nm and Δaxis was 0 to 1.5°.

FIG. 20 is a diagram in which the results of Examples and Comparative Examples are plotted, and it was found that all of Examples satisfied the relationships of the expression (1) and the expression (2).

### EXPLANATION OF REFERENCES

10A, 10B, 10C: optical film
12A, 12B, 12C: change region
20: forming die having concave forming surface
22: film
24: film on which concave surface shape is transferred
26: forming die having convex forming surface
28: film on which convex surface shape is transferred
30: coating film
32: filter
34: transmissive region
36: light shielding region
40: alignment film including photo-aligned group
42: mask
44: wire grid
46: opening portion
48: light shielding portion
50, 52: optically anisotropic film
54: convex curved surface portion
56: plane portion
60A, 60B: laminate
62: absorptive polarizer
64: optically anisotropic film
66: positive C-plate
68: cholesteric liquid crystal layer
70: linear polarization-type reflective polarizer
72: composite lens
74, 90: laminate
76, 88: lens
78, 86: half mirror
80: virtual reality display device
82: image display apparatus
84: circularly polarizing plate
92: ray

What is claimed is:

1. An optical film having a change region where at least one of an in-plane retardation or an in-plane slow axis direction is changed,
wherein, in a case where the in-plane retardation is changed in the change region, the in-plane retardation gradually changes from a center of the change region toward an outer direction, and
in a case where the in-plane slow axis direction is changed in the change region, a line which passes through the center of the change region and is parallel to an average direction of in-plane slow axes of the change region is defined as a first reference line, a line which passes through the center of the change region and is orthogonal to the first reference line is defined as a second reference line, and two lines which pass through the center of the change region and form an angle of 45° with the first reference line and the second reference line are defined as third reference lines, the in-plane slow axis direction at the center is parallel to the average direction of the in-plane slow axes, and the in-plane slow axis direction on the third reference lines gradually changes from the center of the change region toward the outer direction.

2. The optical film according to claim 1,
wherein, in the change region, an average value of the in-plane retardation at a wavelength of 550 nm is 100 to 300 nm.

3. The optical film according to claim 1,
wherein, in a case where the in-plane retardation is changed in the change region, the in-plane retardation gradually decreases from the center of the change region toward the outer direction.

4. The optical film according to claim 1,
wherein, in the change region, a point P1 and a point P2 satisfying a relationship of the following requirement 1 are provided in two adjacent divided regions surrounded by the first reference line and the third reference lines, and
in the change region, a point P3 and a point P4 satisfying a relationship of the following requirement 2 are provided in two adjacent divided regions surrounded by the second reference line and the third reference lines,
the requirement 1: an orientation of inclination of an in-plane slow axis at the point P1 with respect to the first reference line, the point P1 being provided in one region of the two adjacent divided regions surrounded by the first reference line and the third reference lines, is opposite to an orientation of inclination of an in-plane slow axis at the point P2 with respect to the first reference line, the point P2 being provided in the other region of the two divided regions, being located on a line which passes through the point P1 and is orthogonal to the first reference line, and having a distance from the first reference line on the orthogonal line, which is equal to that of the point P1, and
the requirement 2: an orientation of inclination of an in-plane slow axis at the point P3 with respect to the second reference line, the point P3 being provided in one region of the two adjacent divided regions surrounded by the second reference line and the third reference lines, is opposite to an orientation of inclination of an in-plane slow axis at the point P4 with respect to the second reference line, the point P4 being provided in the other region of the two divided regions, being located on a line which passes through the point P3 and is orthogonal to the second reference line, and having a distance from the second reference line on the orthogonal line, which is equal to that of the point P3.

5. A laminate comprising:
the optical film according to claim 1; and
an absorptive polarizer,
wherein an angle between the average direction of the in-plane slow axes of the change region in the optical film and an absorption axis of the absorptive polarizer is in a range of 40° to 50°.

6. An optically anisotropic film having a convex curved surface portion,
wherein relationships of an expression (1) and an expression (2) are satisfied,
$${( Δ Re )}^{1 / 2} + {( Δ axis )}^{1 / 2} \leq 10 \times ( L / R - 0.1 ) , \qquad the expression ( 1 )$$
$$L / R \geq 0.3 \qquad the expression ( 2 )$$
R represents a numerical value R in a case where a minimum curvature radius of the convex curved surface portion is denoted by R (mm),
L represents a numerical value L in a case where a half value of an equivalent circle diameter of the convex curved surface portion as observed from a normal direction of a tangent plane at an apex of the convex curved surface portion is denoted by L (mm),
ΔRe represents a numerical value ΔRe in a case where a largest difference in in-plane retardation among differences of in-plane retardation at two positions on the convex curved surface portion at a wavelength of 550 nm is denoted by ΔRe (nm), and
Δaxis represents a numerical value Δaxis in a case where a largest angle among angles between in-plane slow axes at the two positions on the convex curved surface portion as observed from the normal direction of the tangent plane at the apex of the convex curved surface portion is denoted by Δaxis (°).

7. A display device comprising:
the optically anisotropic film according to claim 6.

8. The display device according to claim 7,
wherein the display device is a virtual reality display device.
